(19) United States
(12) Patent Application Publication
(10) Pub. No.: US 2004/0106005 A1
(43) Pub. Date: Jun. 3, 2004

(54) Luminescent element

(76) Inventors: Yuji Hamada, Heguri-cho (JP); Tsuyoshi Tsujioka, Nishiimagawa (JP); Kazuki Nishimura, Asahigaoka-cho (JP)

Correspondence Address: Kubovcik & Kubovcik, The Farragut Building, Suite 710, 900 17th Street N W, Washington, DC, 20006, US

(21) Appl. No.: 10/468,254

(22) PCT Filed: Feb. 19, 2002
(86) PCT No.: PCT/JP02/01400

(30) Foreign Application Priority Data
Feb. 20, 2001 (JP) 2001-44109
Sep. 3, 2001 (JP) 2001-265805
Sep. 27, 2001 (JP) 2001-297536

(51) Int. Cl. B32B 9/00

(52) U.S. Cl. 428/690

(57) ABSTRACT

A luminescent element of a element structure having electrode and, being held between them, a luminescent solution containing a luminescent material and a solvent, wherein the luminescent solution further contains a luminescence promoting additive which comprises a nonionic compound having a diether structure, a crown ether structure or a polyethylene glycol structure and has the function to stabilize the luminescent material being ionized, and the solvent comprises a halogen-containing benzene derivative.

### TECHNICAL FIELD

The invention relates to electrochemical luminescent (ECL) elements available as a display.

### BACKGROUND ART

In recent years, high density integration of semiconductor circuits has progressed and high-performance information terminals have become compact and also portable. For this reason, research of thin, lightweight and low power consuming display devices is stepping up. For example, liquid crystal displays (LCD) cover from displays of small portable devices through those of notebook computers and have developed so as to replace cathode-ray tube displays (CRT). Moreover, organic electroluminescent (EL) elements and the like attract attention as next-generation display devices which can also bear animation.

The electrochemical luminescent (ECL) element is one of display devices such as those mentioned above. The ECL element, which is a self-light emitting element like the organic EL element, is characterized most strikingly in that luminescence is obtained from a solution. The ECL element has a very simple structure in which a solution containing a luminescent molecule is sandwiched between two electrodes: electrode/solution/electrode. Therefore, the ECL element is advantageous in that no thin film forming machine, which is required by solid organic EL elements, is required and that the element is very easy to produce.

The ECL is light emitted when a luminescent molecule is electrochemically excited through recombination of careers and then the resulting exciton returns to a ground state. In a narrow sense, an anion radical and a cation radical are generated in a solution, and an exciton is generated through their collision and recombination. Specifically, luminescence takes place in the following process.

\mathring{1} When an electric field (1 or more kV/cm) is applied to a solution, at a cathode interface, an electron is injected into a luminescent molecule, so that an anion radical generates.

At an anode interface, an electron is drawn out from a luminescent electron, so that a cation radical generates.

\mathring{2} These ions move toward counter electrodes by action of an electric field. During such movement, a collision of the anion radical and the cation radical results in recombination of charges.

\mathring{3} A luminescent molecule is excited with the energy released during the recombination to form an exciton.

\mathring{4} When the exciton is deactivated to a ground state, it emits energy as light. It is noted that, in such a case, the luminescent molecule may be deactivated via a singlet exciton (S₁) (fluorescence) or via a triplet exciton (T₁) (phosphorescence).

Research of the ECL has been done for a long time. In the 1960s it was reported that 9,10-diphenylanthracene emits light in acetonitrile (reference: A. J. Bard et al., J. Am. Chem. Soc., 87, 139 (1965)). Then, condensed multicyclic aromatics with a more high fluorescence quantum yield, such as rubrene, were examined as a luminescent material (reference: L. R. Faulkner et al., J. Am. Chem. Soc., 110, 112 1988, L. R. Faulkner et al., J. Electroanal. Chem. 242, 107, 1988, A. Kapturkiewicz et al., J. Electroanal. Cem., 302, 131, 1991)).

In these examinations, an organic solvent such as acetonitrile (CH₃CN) was mainly used as a solvent. Moreover, a supporting electrolyte comprising an ionic compound was used for imparting ion conductivity to a solution. In this system, although luminescence could be obtained, quenching caused by a side reaction between the supporting electrolyte and a luminescent material or polarization of the charge occurred, so that stability as an element was not achieved.

Next, Ru salts or Mo salts were used as a luminescent material (reference: A. J. Bard et al., J. Am. Chem. Soc., 103, 512, (1981), D. G. Nocera et al., J. Am. Chem. Soc., 110, 2764 (1988), A. J. Bard et al., J. Am. Chem. Soc., 104, 2641 (1982), H. Miyama et al., J. Elecrtochem. Soc., 135, 2986 (1988), D. G. Nocera et al, J. Phys. Chem., 95, 6919 (1991)). These metal salts are dissolved more easily than condensed multicyclic aromatics such as rubrene into acetonitrile. It was also reported that presence of some H₂O increases the solubility of those salts, resulting in increase in luminescence intensity.

In such a system, a luminescent material dissociates in a solution (for example, RX₂→R²⁺+2X) to exist as ions and, therefore, a system with a high ion conductivity can be realized and ECL luminescence can be obtained (R²⁺+e→R⁺, R²⁺+h⁺→R³⁺, R⁺+R³⁺→R²⁺+R^{2+*}) without addition of any supporting electrolyte. However, difficulty of performing charge injection (R²⁺+h⁺−R³⁺) on an anode causes a problem that X⁻ is oxidized in advance and a problem that hydrogen generates (2H⁺+2e→H₂↑) at a cathode. For this reason, there is a problem that it is impossible to obtain stable luminescence and a high luminance.

So, in the 1980s, systems using no supporting electrolyte was tested (reference: E. Schnedler et al., J. Elecrtochem. Soc., 129, 1289 (1982)). Acetonitrile was used as a solvent, rubrene or the like was used as a luminescent material. Deterioration caused by a supporting electrolyte did not take place. Therefore, the stability of an element could be improved.

Accordingly, the system mentioned above is at present believed to be most suitable as an ECL element. However, this system has problems in that an electric current is hard to pass therethrough and that a high luminance can not be obtained because of its poor ion conductivity.

### DISCLOSURE OF THE INVENTION

An object of the present invention is to provide an electrochemical luminescent element which can be allowed to emit light with stability and with a high luminance.

Another object of the present invention is to provide an electrochemical luminescent element which can form a pixel region easily and can support multicoloration and full coloration by imparting different colors to two or more pixels and to provide a process for manufacture thereof.

The electrochemical luminescent element according to a first aspect of the present invention is characterized in that a luminescent solution containing a luminescent material and a solvent has an element structure in which the solution is sandwiched between a pair of electrodes and that a luminescence promoting additive comprising a nonionic compound which stabilizes a luminescent material is contained in the luminescent solution.

In the present invention, since the luminescence promoting additive is contained in the luminescent solution, it is possible to stabilize the luminescent material ionized by injection of careers from an electrode and to obtain a high luminance.

The luminescent material used in the present invention is not particularly restricted if it can be used as a luminescent material of an ECL. As a luminescent material of an ECL, a material with the following characteristics is used preferably.

\mathring{1} A material has fluorescence or phosphorescence in the visible region and a luminescent molecule itself exhibits a high luminescent (fluorescent or phosphorescent) quantum yield.

\mathring{2} A luminescent molecule forms an anion radical or a cation radical easily in a solution through injection of a career from an electrode.

\mathring{3} A luminescent molecule dissolves in a solvent easily.

\mathring{4} A luminescent molecule and an ion generated are stable in a solution.

Examples of luminescent materials having the above-mentioned characteristics include condensed multicyclic aromatic compounds and organometallic compounds which have fluorescence or phosphorescence in the visible region. In the present invention, one kind of luminescent material may be used alone or, alternatively, two or more kinds of luminescent materials may be used in combination.

The above-mentioned condensed multicyclic aromatic compounds are exemplified by naphthacene derivatives, anthracene derivatives, pentacene derivatives and perifuranten derivatives.

The naphthacene derivatives are exemplified by the compounds having a structure of the following formula.

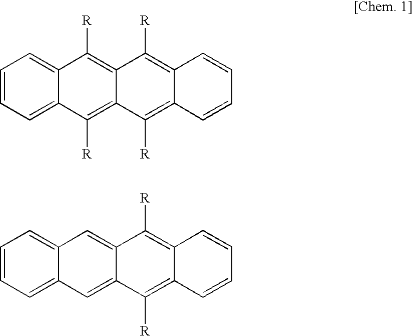

wherein, Rs may be mutually the same or different and denote hydrogen, an alkyl group having 1-5 carbons, a phenyl group, a naphthyl group or an anthryl group.

The phenyl group, the naphthyl group and the anthryl group are substituents having the structures shown below.

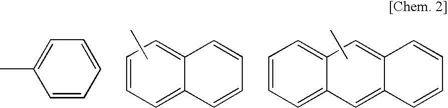

The anthracene derivatives are exemplified by those having a structure of the following formula.

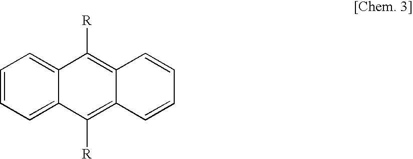

wherein, Rs may be mutually the same or different and denote hydrogen, an alkyl group having 1-5 carbons, a phenyl group, a naphthyl group or an anthryl group.

The pentacene derivatives are exemplified by those having a structure of the following formula.

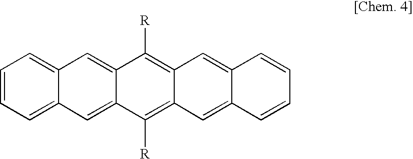

wherein, Rs may be mutually the same or different and denote hydrogen, an alkyl group having 1-5 carbons, a phenyl group, a naphthyl group or an anthryl group.

The perifuranten derivatives are exemplified by those having a structure of the following formula.

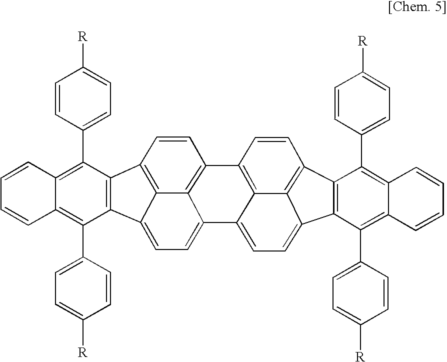

wherein, Rs may be mutually the same or different and denote hydrogen or an alkyl group having 1-5 carbons.

As iridium-containing organometallic compounds, those having a structure of the following formula are mentioned.

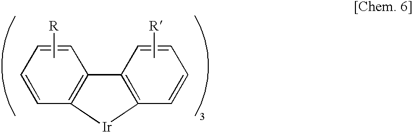

wherein, R and R′ may be mutually the same or different and denote hydrogen or an alkyl group having 1-5 carbons.

Specific examples of the luminescent materials of anthracene derivatives include 9,10-diphenylanthracene (DPA) having the following structure.

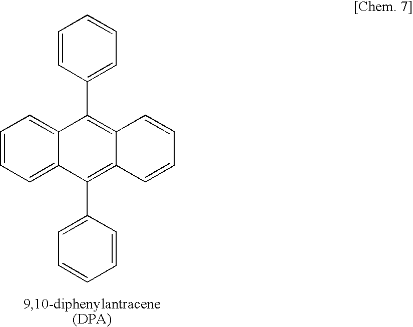

Specific examples of the luminescent materials of the naphthacene derivatives include 5, 12-diphenylnaphthacene (DPN) and rubrene which have the structures shown below.

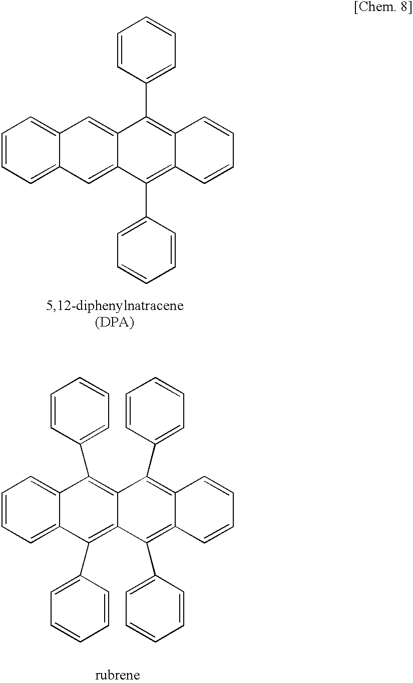

FIG. 5 is a diagram showing the emission spectra of DPA, DPN and rubrene mentioned above. As shown in FIG. 5, DPA shows blue luminescence, DPN shows green luminescence, and rubrene shows yellow luminescence.

Specific examples of luminescent materials comprising pentacene derivatives include 6,13-diphenylpentacene having the structures shown below.

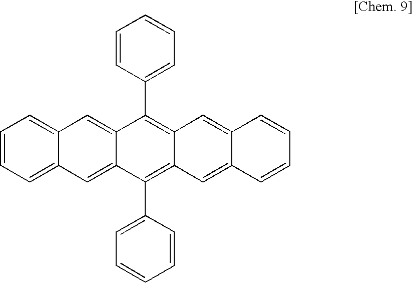

Specific examples of luminescent materials comprising perifurantene derivatives include dibenzotetra(methylphenyl)perifuranten having the structure shown below.

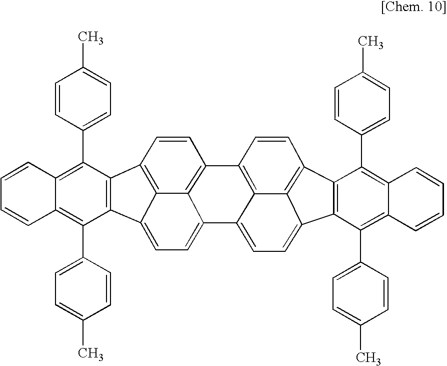

Specific examples of luminescent materials comprising iridium-containing organometallic compounds include tris(2-phenylpyridine)iridium having the structure shown below.

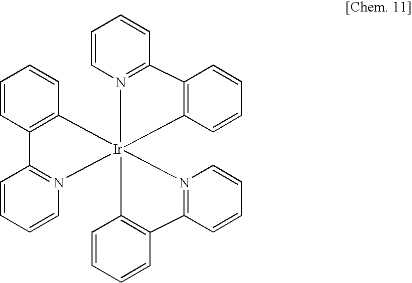

The luminescence promoting additive used in the present invention comprises a nonionic compound which stabilizes a luminescent material. Examples of such a nonionic compound include those having a diether structure, a crown ether structure or a polyethylene glycol structure. In the present invention, one kind of luminescence promoting additive may be used alone or, alternatively, two or more kinds of luminescence promoting additives may be used in combination.

Examples of nonionic compounds having a diether structure include those represented by the formula shown below.

R₁—O—R₂—O—R₃ [Chem. 12]

wherein, R₁ and R₃ may be mutually the same or different and denote hydrogen, an alkyl group having 1-10 carbons or aromatic groups having the structures shown below.

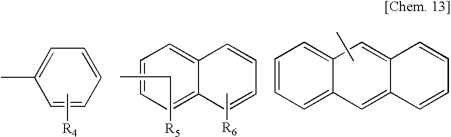

wherein, R₄, R₅ and R₆ may be mutually the same or different and denote hydrogen or an alkyl group having 1-5 carbons, R₂ denotes an alkylene group having 1-10 carbons or divalent aromatic substituents shown below.

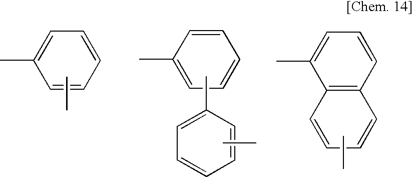

Examples of substances having a polyethylene glycol structure include polyethylene glycols represented by the formula shown below.

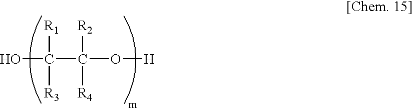

wherein, R₁, R₂, R₃ and R₄ may be mutually the same or different and denote hydrogen, an alkyl group having 1-5 carbons or a phenyl group; m indicates an integer of 2 to 250. m indicates an integer of 2 to 250.

Examples of substances having a crown ether structure include crown ethers represented by the formula shown below.

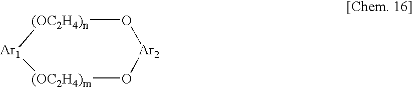

wherein, Ar₁ and Ar₂ may be mutually the same or different and denote C₂H₄ or a phenylene group or a naphthylene group shown below.

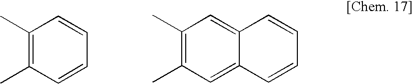

Furthermore, n and m may be mutually the same or different and denote an integer of 1 to 10.

Specific examples of the luminescence promoting additive include 1,2-dimethoxyethane, 1,2-diethoxyethane, bis(2-ethoxyethyl) ether, 1,2-diphenoxyethane, 1,2-dibenzyloxyethane, 1,2-bis(tosyloxy)ethane, ethylene glycol bis[4-(ethoxycarbonyl)phenyl] ether, 1,3-diphenoxybenzene, ethylene glycol dibenzoate, diphenoxymethane, 1,4-diphenoxybenzene, 3,3′-ethylenedioxydiphenol, polyethylene glycol and dibenzo-18-crown-6-ether.

The following are the structural formulas of 1,2-dimethoxyethane, 1,2-diethoxyethane, bis(2-ethoxyethyl) ether, 1,2-diphenoxyethane, 1,2-dibenzyloxyethane and 1,2-bis(tosyloxy)ethane.

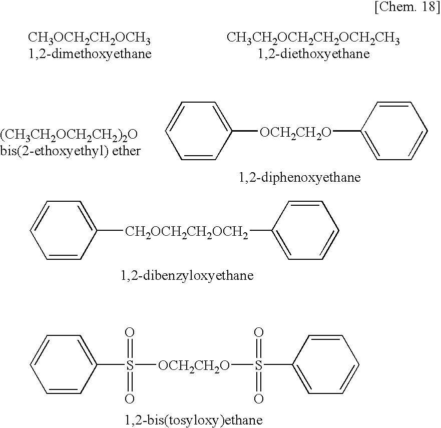

The following are the structural formulas of ethylene glycol bis[4-(ethoxycarbonyl)phenyl] ether, ethylene glycol dibenzoate, 1,3-diphenoxybenzene and 1,4-diphenoxybenzene.

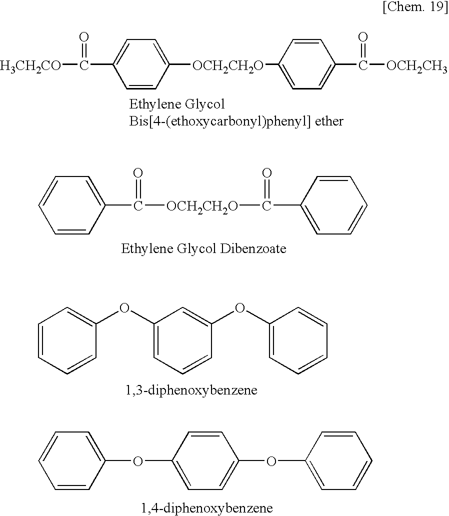

The following are the structural formulas of 3,3′-ethylene dioxydiphenol, diphenoxymethane and dibenzo-18-crown-6-ether.

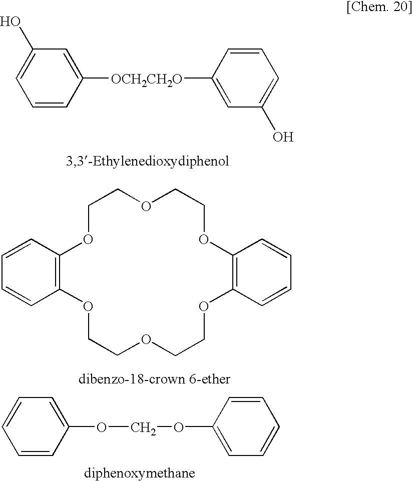

In the present invention, a luminescence promoting additive is contained in a luminescent solution. The luminescence promoting additive stabilizes a luminescent material ionized through injection of a career from an electrode, so that a high luminance can be obtained. The action and effect of such a luminescence promoting additive is explained below.

In the luminescence mechanism of an ECL as described above, an anion radical of a luminescent molecule generated at a cathode interface and a cation radical of the luminescent molecule generated at an anode interface, respectively, move toward the counter electrodes through the action of the electric field. When the anion radical and the cation radical collide with each other, a luminescent molecule is excited to form an exciton. When the exciton deactivates to its ground state, it emits energy as light.

Therefore, to obtain a high luminance, it is necessary to increase the probability that an anion radical and a cation radical will collide with each other on the way of their moving toward the counter electrodes rapidly under ionic conduction.

Since the luminescence promoting additive in the present invention stabilizes an ionized luminescent material, i.e., an anion radical or a cation radical of a luminescent molucule, to prolong the life thereof, it can increase the probability that the anion radical and the cation radical will collide with each other. Therefore, according to the present invention, a high luminance can be obtained.

It is reported that in a system using rubrene as a luminescent material, a cation radical of rubrene is less stable and has a shorter life in comparison with an anion radical of rubrene (reference: A. J. Bard et al., J. Elecrtoanal. Chem. Soc., 127, 104, (1980), D. K. Roe et al., J. Am. Chem. Soc., 88, 4578, (1966)). If a cation radical has a short life, ionic conduction will not occur and the cation radical will quench near an anode. This will cause shortage of cation radicals to reduce the probability that cation radicals and anion radicals will collide with each other. This will cause a low luminance. It is known that a solvent tends to solvate an anion radical of rubrene to stabilize the anion radical. Therefore, to obtain a high luminance, stabilization of a cation radical is needed.

The luminescence promoting additive in the present invention can stabilize, for example, such a less stable cation radical of rubrene. 1,2-Diphenoxyethane, which is a luminescence promoting additive, stabilizes a cation radical of rubrene when it is arranged around the cation radical of rubrene as shown in the following scheme.

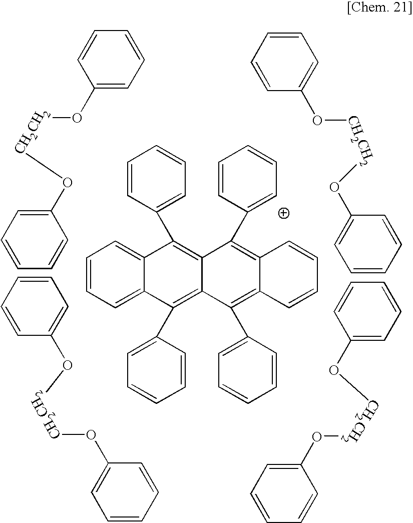

Stabilization of a cation radical prolongs the life of the radical and makes the ionic conduction to the direction toward the counter electrode easy to occur. Therefore, such stabilization increases the probability that an anion radical and a cation radical will collide with each other, resulting in increase in luminance.

In the present invention, the molar ratio of the luminescence promoting additive to the luminescent material (molar concentration of luminescence promoting additive/molar concentration of luminescent material) is preferably 0.1 to 1000 and more preferably 10 to 500. If the content of the luminescence promoting additive is too less or too much, the effect of the present invention in which a high luminescence intensity can be obtained may not fully be acquired.

In ECLs, a solvent is used in order to dissolve a luminescent material to form a luminescent solution. The solvent used for ECLs preferably has the following characteristics:

\mathring{1} To dissolve a luminescent material well.

\mathring{2} A resulting cation and anion radicals of a luminescent molecule move to the counter electrodes easily. For example, the viscosity is low.

\mathring{3} Even if voltage is applied, the molecule itself does not change chemically and is stable.

\mathring{4} The volatility of the solvent is small and after preparation of an ECL element its element structure is maintained with stability.

\mathring{5} The solvent is easy to refine. In particular, removal of water or oxygen can be done easily.

Acetonitrile has been employed conventionally as a solvent of ECLs because of its good ion conductivity. However, acetonitrile is not so good in the solubility of condensed multicyclic aromatics such as rubrene. In the present invention, since a luminescence promoting additive is used, it is possible to stabilize an ionized luminescent material and increase its ion conductivity. Therefore, it becomes possible to use solvents other than acetonitrile. In the solubility of the condensed multicyclic aromatic compound, which is a luminescent material, halogen-containing benzene derivatives are excellent. Therefore, in the present invention, halogen-containing benzene derivatives may be employed as a solvent.

In the present invention, a mixed solvent containing a first solvent consisting of a halogen-containing benzene derivative and a second solvent other than the halogen-containing benzene derivative may be used as a solvent. As each of the first and second solvents, one kind of solvent may be used alone or, alternatively, two or more kinds of solvents may be used.

The halogen-containing benzene derivative has characteristics of being chemically stable, being of small volatility and being easy to refine. Specific examples of such a halogen-containing benzene derivative include chlorobenzene, dichlorobenzene, trichlorobenzene, fluorobenzene, difluorobenzene, trifluorobenzene, bromobenzene, dibromobenzene and chloronaphthalene.

As the second solvent, solvents having a polarity are preferably used from a viewpoint of increasing ion conductivity. To stabilize an ionized luminescent material, that is, an anion or cation radical of a luminescent molecule, preferred are solvents capable of solvating these ions. From such a viewpoint solvents of high polarities are preferably used. The level of the polarity of a solvent can be expressed in terms of dielectric constant. The solvent which increases ion conductivity preferably has a dielectric constant of 1.9 to 90 and more preferably 1.9 to 40.

The following are specific examples of the second solvent. The number in the parenthesis indicates the dielectric constant.

Tetrahydrofuran (7.4)

Acetonitrile (38)

2-Methyltetrahydrofuran (6.2)

Toluene (2.4)

Propylene carbonate (65)

Ethylene carbonate (90)

Benzonitrile (25.2)

Normal hexane (1.9)

Cyclohexane (2.0)

Acetone (20.7)

N,N-Dimethylformamide (37)

Nitrobenzene (35.7)

1,3-Dioxolane (7.1)

Furan (2.95)

Benzotrifluoride (9.14)

The mix volume ratio of the first solvent to the second solvent (the first solvent/the second solvent) is preferably 99/1 to 10/90 and more preferably 80/20 to 50/50.

In the present invention, the concentration of a luminescent material in a luminescent solution is preferably 0.0001 to 0.5 mol/l and more preferably 0.005 to 0.2 mol/l.

A solvent or a compound which constitutes a solvent used in the present invention preferably has a coefficient of viscosity at ordinary temperature within the range of 0.2 to 20 mPa.S. The following are examples of solvents having a coefficient of viscosity within the range mentioned above. The number in the parenthesis indicates the coefficient of viscosity (mPa.S).

Ethylene glycol (19.9)

Propylene carbonate (2.52)

1-Chloronaphthalene (2.94)

o-Dichlorobenzene (1.30)

Toluene (0.58)

Acetonitrile (0.38)

Tetrahydrofuran (0.48)

Normal hexane (0.31)

Acetone (0.32)

Nitrobenzene (2.01)

Cyclopentane (0.23)

In the ECL element of the present invention, a luminescent solution may be made emit light through application of a direct current voltage to the pair of electrodes or, alternatively, the luminescent solution may be made emit light through application of an alternating current voltage to the pair of electrodes. The alternating current voltage to be applied may be an alternating current voltage of sine wave or rectangular wave which draws a waveform in which plus and minus reverse within one cycle.

Since the ECL element is a self-luminescent element, for extracting light it is preferable that at least one of the pair of electrodes be excellent in light transmittance. Therefore, it is preferable that at least one of the pair of electrodes have a visible light transmittance of 30% or more.

Moreover, it is preferable that the electrodes be transparent electrodes. Tfore, it is preferable that at least one the pair of electrodes be formed of an indium tin oxide (ITO) or the like. At least one of the pair of electrodes may be formed of SnO₂ with Sb added; In₂O₃ with ZnO added; In₂O₃ with SnO₂ added; At least one metal oxide selected from In₂O₃, SnO₂l ZnO and Cd₂SnO₄, each having been doped with fluorine; an elemental metal selected from Li, Na, Cs, Sr, Ba, Ca, Eu, Mg, In, Mn, Ti, Ta, V, Al, Zn, Mo, Ag, Fe, Cu, Sn, Bi, Ni, Pd, Au, Ir and Pt, and their alloy metals; or a lanthanide hexaboride compound selected from LaB₆, CeB₆, PrB₆, NdB₆, SmB₆, EuB₆ and GdB₆.

Moreover, in the present invention, the pair of electrodes may be electrodes made of different materials. In this case, it is preferable that the difference in work function between the different materials is 0.1 to 3.55 eV. By setting the difference in work function into such a range, it is possible to increase the luminescent efficiency.

The sheet resistance of the pair of electrodes is preferably 1000 Ω/□ or less and more preferably 20 Ω/□ or less.

Moreover, in the present invention, it is preferable that at least one of the pair of electrodes be formed on a glass substrate or a plastic substrate. Furthermore, to prevent the luminescent material from deterioration caused by external light (ultraviolet light), it is preferable that an ultraviolet absorbing film is disposed outside the substrate.

In the present invention, the gap between the pair of electrodes is preferably 100 μm or less and more preferably 10 μm or less. When such a gap is formed, ionic conduction in the luminescent solution within the gap is performed effectively. As the method of forming such a gap, it is preferred to make a spacer intervene between the pair of electrodes. Such a spacer may be, for example, a spacer made of resin or silica. The spacer may be, for example, spherical or cylindrical in shape.

A second aspect of the present invention relates to a process for manufacturing an electrochemical luminescent element. Namely, the manufacture process of the present invention is a process for manufacturing an electrochemical luminescent element having an element structure in which a luminescent solution containing a luminescent material and a solvent is held between a pair of electrodes, the process being characterized by forming each of the pair of electrodes on a substrate, applying a sealing agent to a peripheral portion of each of the substrates, bonding the substrates so that the electrode surfaces are opposed to each other, exhausting air from the hollow portion between the substrates, and injecting the luminescent solution between the substrate.

According to such a manufacture process, an electrochemical luminescent element can be manufactured efficiently.

The electrochemical luminescent element according to a third aspect of the present invention is characterized by using, as a luminescent material, a material which emits light from its triplet state. Examples of such a luminescent material include iridium-containing organic compounds. One specific example of the iridium-containing organic compounds is tris(2-phenylpyridine)iridium. When using such a luminescent material, a high luminance can be obtained even when the luminescent material contains no luminescence promoting additive.

In the present invention, examples of the iridium-containing organic compounds, which are luminescent materials which emit light from their triplet state, include compounds represented by the following formulas (Chem. 22) to (Chem. 28).

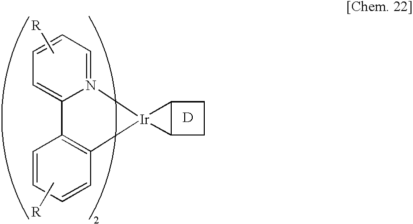

wherein, Rs may be the same or different and denote CₙH₂ₙ₊₁ (n is an integer of 1 to 10), a phenyl group, a naphthyl group, a CN group, N(CₙH₂ₙ₊₁)₂ (n is an integer of 1 to 10), COOCₙH₂ₙ₊₁ (n is an integer of 1 to 10), F, Cl, Br or I.

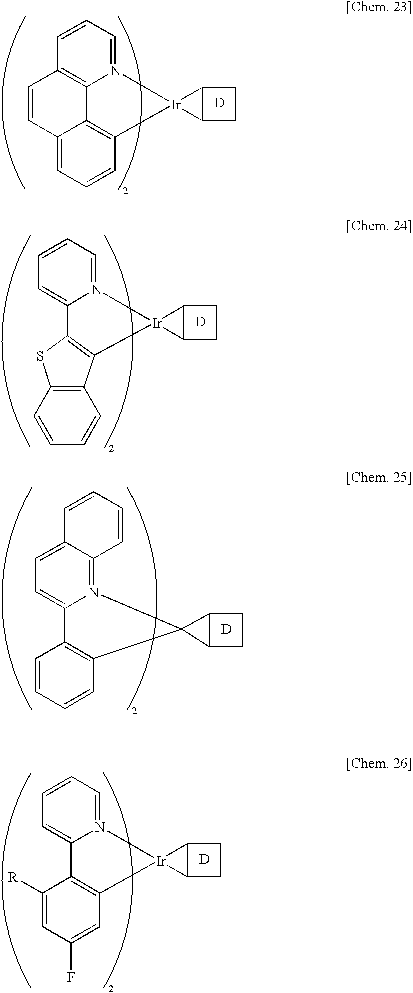

In (Chem. 22)-(Chem. 26), D is a ligand having the structure shown below:

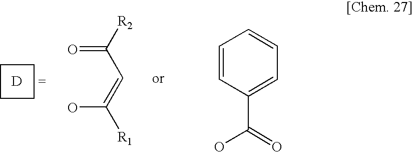

wherein, R₁ and R₂ may be the same or different and denote CₙH2ₙ₊₁ (n is an integer of 1 to 10), a phenyl group, a naphthyl group, a CN group, N(CₙH₂ₙ₊₁)₂ (n is an integer of 1 to 10), COOCₙH₂ₙ₊₁ (n is an integer of 1 to 10), F, Cl, Br, I, CF₃, a furyl group or a thienyl group.

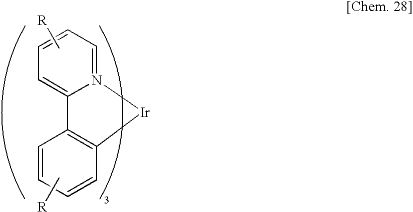

wherein, Rs may be the same or different and denote CₙH₂ₙ₊₁ (n is an integer of 1 to 10), a phenyl group, a naphthyl group, a CN group, N(CₙH₂ₙ₊₁)₂ (n is an integer of 1 to 10), COOCₙH₂ₙ₊₁ (n is an integer of 1 to 10), F, Cl or I.

Other examples of the iridium-containing organic compounds used as a luminescent material in the present invention include those having the structures shown in (Chem. 29) to (Chem. 32).

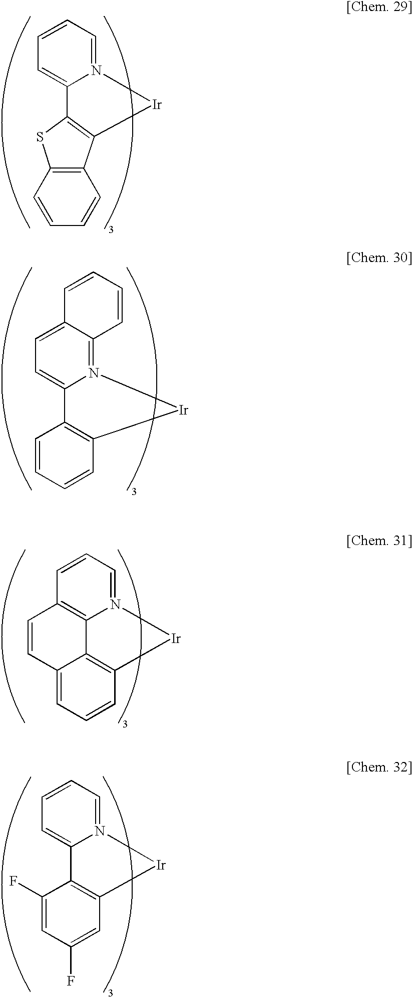

The electrochemical luminescent element of a fourth aspect of the present invention is characterized by having a luminescent section in which a luminescent solution containing a luminescent material and a solvent is held while being divided into every pixel and pair of electrodes which are arranged so as to sandwich the luminescent section.

In the fourth aspect, it is preferable that the luminescent solution in the luminescent section be held in a gel state. Such holding of the luminescent solution in a gel state is preferably done by macromolecules contained in the luminescent solution. Such macromolecules are preferably those formed by making a luminescent solution contain a polymerizable material and then polymerizing the polymerizable material.

As the polymerizable material, a polymerizable monomer, a polymerizable oligomer, a polymerizable polymer, etc. are used. The content of the polymerizable material is not particularly limited and is preferably a content such that the luminescent solution has, before the polymerization, a viscosity such that the solution can be applied and after the polymerization a gel state where the luminescent solution can be held. Generally, preferred is approximately 5 to 50% by weight relative to the solvent.

The manufacture process according to a fifth aspect of the present invention is characterized by comprising a step of applying a luminescent solution containing a luminescent material, a solvent and a polymerizable material onto a substrate while patterning so that it may be divided into every pixel and a step of polymerizing the polymerizable material in the applied luminescent solution to cause the luminescent solution to gel, thereby forming a luminescent section.

As the luminescent material, solvent and polymerizable material in the manufacture process of the fifth aspect, ones the same as those used in the invention of the above-mentioned luminescent element may be used. The method of applying the luminescent solution onto the substrate while pattering so that the solution may be divided into every pixel may be, but is not limited to, the inkjet method, the screen printing method and the like. Any method may be employed if it can apply the luminescent solution while patterning so that the solution may be divided into every pixel.

After applying the luminescent solution onto the substrate while patterning so that the solution may be divided into every pixel, it is possible to form a luminescent section by polymerizing the polymerizable material in the luminescent solution to cause the luminescent solution to gel. The method of polymerizing the polymerizable material in the luminescent solution may be a polymerization method by ultraviolet irradiation, a polymerization method by heating, and the like.

In the luminescent element of the fourth aspect, the luminescent solution is held within pixel regions without flowing because the luminescent solution is held while being divided into every pixel. Therefore, pixels can be formed without providing partitions or the like and the pixels can be formed easily. Moreover, since different luminescent colors can be allocated for pixel to pixel, the luminescent element can support multicoloration and full coloration. For example, when colors of RGB are allocated to pixels, a full color display can be obtained.

According to the manufacture process of the fifth aspect, the above-mentioned luminescent element of the fourth aspect can be manufactured easily. In the stage of application, the viscosity of the luminescent solution can be set low because the polymerizable material is contained in a state before polymerization. Therefore, it is possible to do patterning easily while dividing to every pixel. After the application, when polymerizing the polymerizable material in the luminescent solution, it is possible to hold the luminescent solution in a gel state.

### BRIEF DESCRIPTION OF THE DRAWINGS

FIG. 1 is a sectional view showing the structure of an ECL element of one embodiment according to the first aspect of the present invention.

FIG. 2 is a perspective view showing a step of manufacturing an ECL element of one embodiment according to the first aspect of the present invention.

FIG. 3 is a perspective view showing a step of manufacturing an ECL element of one embodiment according to the first aspect of the present invention.

FIG. 4 is a plan view showing an ECL element of one embodiment according to the first aspect of the present invention.

FIG. 5 is a diagram showing the emission spectra of DPA, DPN and rubrene, which are luminescent materials.

FIG. 6 is a perspective view showing manufacture steps of one embodiment according to the manufacture process of the second aspect of the present invention.

FIG. 7 is a sectional view showing a structure of an ECL element of another embodiment according to the first aspect of the present invention.

FIG. 8 is a schematic sectional view showing a luminescent element of one embodiment according to the fourth aspect of the present invention.

FIG. 9 is a schematic sectional view showing one example of a manufacture step of the fifth aspect of the present invention.

### BEST MODE FOR CARRYING OUT THE INVENTION

FIG. 1 is a sectional view showing the structure of an ECL element of one embodiment according to the present invention. An electrode 2 made of indium tin oxide (ITO) is disposed on a glass substrate 4. Moreover, an electrode 3 made of ITO is disposed on a glass substrate 5. A luminescent solution 1 is held between electrode 2 and electrode 3. A spacer 6 interposes between electrodes 2 and 3. The gap between electrodes 2 and 3 is kept constant by the spacer 6.

In the Examples shown below, ECL elements with the structure illustrated in FIG. 1 were prepared by the process described below.

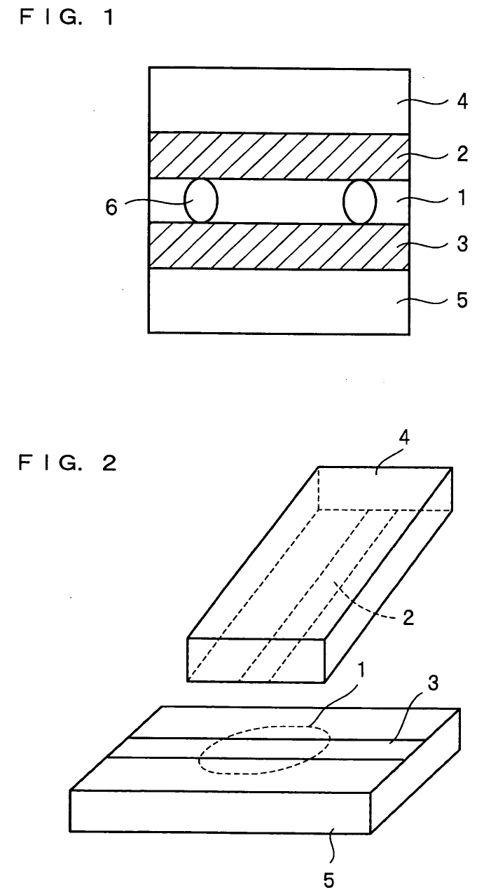

As shown in FIG. 2, electrode 2 and electrode 3 each made of ITO were formed on glass substrate 4 and glass substrate 5, respectively, so as to have a width of 2 mm. These were washed in ethanol for 15 minutes by use of an ultrasonic washer.

After dissolving a predetermined amount of luminescent material in a solvent, a predetermined amount of luminescence promoting additive was added to this solution. A spacer for forming a gap was further added to this solution and was stirred, thereby forming a luminescent solution.

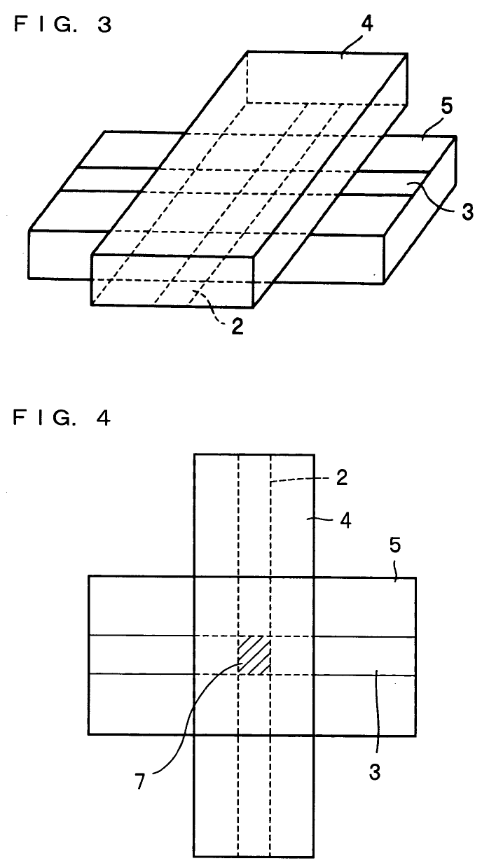

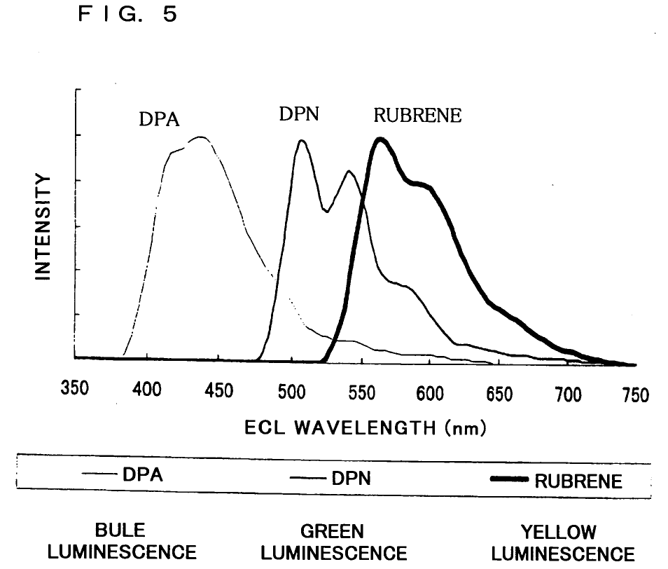

A small amount of luminescent solution 1 prepared in the above manner was dropped, as shown in FIG. 2, to electrode 3 on glass substrate 5. The other glass substrate 4 was put on glass substrate 5 so that electrode 2 and electrode 3 might be opposed and intersect perpendicularly to each other (see FIG. 3). The two substrates 4 and 5 were held and fixed with a clip to form an ECL element.

As shown in FIG. 4, a part in which electrodes 2 and 3 are overlapped each other becomes a luminescent section 7. Electrode 2 and electrode 3 were subjected to positive bias and negative bias, respectively, thereby applying a direct current voltage to the luminescent solution held between electrodes 2 and 3.

In the following Examples and Comparative Example, unless stated otherwise, the sheet resistance of the electrodes is 10 Ω/□ and the gap between the electrodes is 8 μm.

### EXAMPLES 1-7 AND COMPARATIVE EXAMPLES 1-2

As shown in Table 1, ECL elements were prepared using rubrene as a luminescent material, 1,2-diphenoxyethane as a luminescence promoting additive, tetrahydrofuran (THF) as solvent 2 and a variety of halogen-containing benzene derivatives as solvent 1, and were subjected to measurement of luminance. The maximum luminances are shown in Table 1. In the column of Maximum Luminance in Table 1, < > indicates a voltage at which a maximum luminance was obtained. It is noted that no luminescence promoting additive was used in Comparative Example 1.

TABLE 1

| | | | | Luminescent | | |
|---|---|---|---|---|---|---|
| | | | Solvent 2 | Material | Luminescence | Maximum |
| | | | (Vol. Conc. % | (Conc. mol/l) | Promoting | Luminance |
| | | | in Mixed | <Luminescent | Additive | (cd/m²) |
| | | Solvent 1 | Solvent) | Color> | (Conc. mol/l) | <Voltage> |
| Ex. | 1 | Chlorobenzene | THF(50) | Rubrene | 1,2-Diphenoxyethane | 36.9 |
| | | | | (0.01) | (0.1) | <16 V> |
| | | | | <Yellow> | | |
| | 2 | o-Dichlorobenzene | THF(50) | Rubrene | 1,2-Diphenoxyethane | 241 |
| | | | | (0.01) | (0.1) | <16 V> |
| | | | | <Yellow> | | |
| | 3 | m-Dichlorobenzene | THF(50) | Rubrene | 1,2-Diphenoxyethane | 2.9 |
| | | | | (0.01) | (0.1) | <13 V> |
| | | | | <Yellow> | | |
| | 4 | 1,2,4- | THF(50) | Rubrene | 1,2-Diphenoxyethane | 15.3 |
| | | Trichlorobenzene | | (0.01) | (0.1) | <16 V> |
| | | | | <Yellow> | | |
| | 5 | o-Difluorobenzene | THF(50) | Rubrene | 1,2-Diphenoxyethane | 220 |
| | | | | (0.01) | (0.1) | <10 V> |
| | | | | <Yellow> | | |
| | 6 | o-Dibromobenzene | THF(50) | Rubrene | 1,2-Diphenoxyethane | 35.7 |
| | | | | (0.01) | (0.1) | <16 V> |
| | | | | <Yellow> | | |
| | 7 | 1-Chloronaphthalene | THF(50) | Rubrene | 1,2-Diphenoxyethane | 62.5 |
| | | | | (0.01) | (0.1) | <16 V> |
| | | | | <Yellow> | | |
| Comp. | 1 | o-Dichlorobenzene | THF(50) | Rubrene | None | 0.6 |
| Ex. | | | | (0.01) | | <8 V> |
| | | | | <Yellow> | | |
| | 2 | None | THF | Rubrene | 1,2-Diphenoxyethane | 1.5 |
| | | | | (0.01) | (0.1) | <8 V> |
| | | | | <Yellow> | | |

As is clear from Table 1, in Examples 1-7, in which a luminescence promoting additive was added to a luminescent solution according to the present invention, remarkably high luminances were obtained in comparison to Comparative Example 1 containing no luminescence promoting additive.

Based on comparison to Comparative Example 2, in which only THF containing no halogen-containing benzene derivative was used as a solvent, it is revealed that causing a halogen-containing benzene derivative to be contained as a solvent improves the luminance.

### EXAMPLES 8-25

As shown in Table 2, o-dichlorobenzene was used as solvent 1 and various kinds of solvents-were used as solvent 2. Rubrene was used as a luminescent material and 1,2-diphenoxyethane was used as a luminescence promoting additive. The concentrations of these substances contained are as shown in Table 2.

In Examples 8 and 9, THF was used as solvent 2, the concentrations of which were set to volume concentrations of 1% and 90%, respectively.

TABLE 2

| | | | | Luminescent | | |
|---|---|---|---|---|---|---|
| | | | Solvent 2 | Material | Luminescence | Maximum |
| | | | (Vol. Conc. % | (Conc. mol/l) | Promoting | Luminance |
| | | | in Mixed | <Luminescent | Additive | (cd/m²) |
| | | Solvent 1 | Solvent) | Color> | (Conc. mol/l) | <Voltage> |
| Ex. | 8 | o-Dichlorobenzene | THF(1) | Rubrene (0.01) | 1,2-Diphenoxyethane | 120 |
| | | | | <Yellow> | (0.1) | <80 V> |
| | 9 | o-Dichlorobenzene | THF(90) | Rubrene (0.01) | 1,2-Diphenoxyethane | 3 |
| | | | | <Yellow> | (0.1) | <16 V> |
| | 10 | o-Dichlorobenzene | Acetonitrile | Rubrene (0.01) | 1,2-Diphenoxyethane | 183 |
| | | | (50) | <Yellow> | (0.2) | <8 V> |
| | 11 | o-Dichlorobenzene | 2-Methyltetrahydrofuran | Rubrene (0.01) | 1,2-Diphenoxyethane | 225 |
| | | | (50) | <Yellow> | (0.1) | <17 V> |
| | 12 | o-Dichlorobenzene | Toluene (50) | Rubrene (0.01) | 1,2-Diphenoxyethane | 683 |
| | | | | <Yellow> | (0.1) | <100 V> |
| | 13 | o-Dichlorobenzene | Propylene | Rubrene (0.01) | 1,2-Diphenoxyethane | 109.7 |
| | | | carbonate (50) | <Yellow> | (0.5) | <7 V> |
| | 14 | o-Dichlorobenzene | Cyclohexane | Rubrene (0.01) | 1,2-Diphenoxyethane | 522 |
| | | | (50) | <Yellow> | (0.1) | <60 V> |
| | 15 | o-Dichlorobenzene | Benzonitrile | Rubrene (0.01) | 1,2-Diphenoxyethane | 123 |
| | | | (50) | <Yellow> | (0.2) | <13 V> |
| | 16 | o-Dichlorobenzene | Cyclopentane | Rubrene (0.01) | 1,2-Diphenoxyethane | 553 |
| | | | (50) | <Yellow> | (0.2) | <100 V> |
| | 17 | o-Dichlorobenzene | Acetone (50) | Rubrene (0.01) | 1,2-Diphenoxyethane | 3 |
| | | | | <Yellow> | (0.2) | <13 V> |
| | 18 | o-Dichlorobenzene | N,N-Dimethyl- | Rubrene (0.01) | 1,2-Diphenoxyethane | 27 |
| | | | formamide (50) | <Yellow> | (0.2) | <13 V> |
| | 19 | o-Dichlorobenzene | Nitrobenzene | Rubrene (0.01) | 1,2-Diphenoxyethane | 5 |
| | | | (50) | <Yellow> | (0.2) | <13 V> |
| | 20 | o-Dichlorobenzene | 1,3-Dioxorane | Rubrene (0.01) | 1,2-Diphenoxyethane | 17 |
| | | | (50) | <Yellow> | (0.2) | <20 V> |
| | 21 | o-Dichlorobenzene | Furan (50) | Rubrene (0.01) | 1,2-Diphenoxyethane | 79 |
| | | | | <Yellow> | (0.2) | <20 V> |
| | 22 | o-Dichlorobenzene | Trifluoromethyl- | Rubrene (0.01) | 1,2-Diphenoxyethane | 414 |
| | | | benzene (50) | <Yellow> | (0.2) | <80 V> |
| | 23 | o-Dichlorobenzene | Normal hexane | Rubrene (0.01) | 1,2-Diphenoxyethane | 468 |
| | | | (50) | <Yellow> | (0.2) | <60 V> |
| | 24 | o-Dichlorobenzene | Ethylene | Rubrene (0.01) | 1,2-Diphenoxyethane | 30 |
| | | | carbonate (10) | <Yellow> | (0.2) | <50 V> |
| | 25 | o-Dichlorobenzene | Ethylene glycol | Rubrene (0.01) | 1,2-Diphenoxyethane | 10 |
| | | | (10) | <Yellow> | (0.2) | <50 V> |

As is clear from Table 2, even when various kinds of solvents were used as a solvent other than halogen-containing benzene derivatives, high luminances were obtained. In addition, as is clear from Examples 8 and 9, in both cases where the concentrations of solvent 2 were 1% and 90%, sufficient luminescent intensities were obtained.

### EXAMPLES 26-31 AND COMPARATIVE EXAMPLE 3

As shown in Table 3, the concentration of 1,2-diphenoxyethane as a luminescent promoting additive in a luminescent solution was varied and the influence of the variation was examined. The molar ratio of the luminescence promoting additive to the luminescent material (molar ratio of luminescence promoting additive/molar concentration of luminescent material) in each Example is as follows.

Example 26: 0.1

Example 27: 10

Example 28: 20

Example 29: 50

Example 30: 100

Example 31: 500

Example 46 (Table 6): 1000

TABLE 3

| | | | | Luminescent | | |
|---|---|---|---|---|---|---|
| | | | Solvent 2 | Material | Luminescence | Maximum |
| | | | (Vol. Conc. % | (Conc. mol/l) | Promoting | Luminance |
| | | | in Mixed | <Luminescent | Additive | (cd/m²) |
| | | Solvent 1 | Solvent) | Color> | (Conc. mol/l) | <Voltage> |
| Ex. | 26 | o-Dichlorobenzene | Acetonitrile | Rubrene | 1,2-Diphenoxyethane | 0.7 |
| | | | (50) | (0.01) | (0.001) | <8 V> |
| | | | | <Yellow> | | |
| | 27 | o-Dichlorobenzene | Acetonitrile | Rubrene | 1,2-Diphenoxyethane | 8.1 |
| | | | (50) | (0.01) | (0.1) | <8 V> |
| | | | | <Yellow> | | |
| | 28 | o-Dichlorobenzene | Acetonitrile | Rubrene | 1,2-Diphenoxyethane | 183 |
| | | | (50) | (0.01) | (0.2) | <8 V> |
| | | | | <Yellow> | | |
| | 29 | o-Dichlorobenzene | Acetonitrile | Rubrene | 1,2-Diphenoxyethane | 177 |
| | | | (50) | (0.01) | (0.5) | <8 V> |
| | | | | <Yellow> | | |
| | 30 | o-Dichlorobenzene | Acetonitrile | Rubrene | 1,2-Diphenoxyethane | 81.9 |
| | | | (50) | (0.01) | (1) | <4 V> |
| | | | | <Yellow> | | |
| | 31 | o-Dichlorobenzene | Acetonitrile | Rubrene | 1,2-Diphenoxyethane | 10 |
| | | | (50) | (0.01) | (5) | <3 V> |
| | | | | <Yellow> | | |
| Comp. | 3 | o-Dichlorobenzene | Acetonitrile | Rubrene | None | 0.6 |
| Ex. | | | (50) | (0.01) | | <8 V> |
| | | | | <Yellow> | | |

In Examples 26-31 and Example 46, maximum luminances higher than Comparative Example 3 were obtained. Accordingly, an effect caused by the luminescence promoting additive appears when the molar ratio of the luminescence promoting additive to the luminescent material is within the range of 0.1 to 1000. In particular, better results are obtained when the molar ratio is within the range of 10 to 500.

### EXAMPLES 32-41

Various kinds of materials were used as a luminescence promoting additive and the influence of the variation was examined. o-Dichlorobenzene was used as solvent 1 and THF was used as solvent 2. Rubrene was used as a luminescent material.

The results are shown in Table 4.

TABLE 4

| | | | Solvent 2 | Luminescent | | |
|---|---|---|---|---|---|---|
| | | | (Vol. | Material | | Maximum |
| | | | Conc. % in | (Conc. mol/l) | Luminescence | Luminance |
| | | | Mixed | <Luminescent | Promoting Additive | (cd/m²) |
| | | Solvent 1 | Solvent) | Color> | (Conc. mol/l) | <Voltage> |
| Ex. | 32 | o-Dichlorobenzene | THF(50) | Rubrene | 1,2-Dimethoxyethane | 20 |
| | | | | (0.01) | (0.1) | <30 V> |
| | | | | <Yellow> | | |
| | 33 | o-Dichlorobenzene | THF(50) | Rubrene | Ethylene glycol bis[4- | 3 |
| | | | | (0.01) | (ethoxycarbonyl)phenyl] | <30 V> |
| | | | | <Yellow> | ether (0.1) | |
| | 34 | o-Dichlorobenzene | THF(50) | Rubrene | 1,2-Bis(tosyloxy)ethane | 0.8 |
| | | | | (0.01) | (0.1) | <30 V> |
| | | | | <Yellow> | | |
| | 35 | o-Dichlorobenzene | THF(50) | Rubrene | Ethylene glycol | 1 |
| | | | | (0.01) | dibenzoate (0.1) | <30 V> |
| | | | | <Yellow> | | |
| | 36 | o-Dichlorobenzene | THF(50) | Rubrene | 1,3-Diphenoxybenzene | 0.9 |
| | | | | (0.01) | (0.1) | <30 V) |
| | | | | <Yellow> | | |
| | 37 | o-Dichlorobenzene | THF(50) | Rubrene | 3,3′-Ethylene | 0.8 |
| | | | | (0.01) | dioxydiphenol (0.1) | <30 V> |
| | | | | <Yellow> | | |
| | 38 | o-Dichlorobenzene | THF(50) | Rubrene | Polyethylene glycol | 10.1 |
| | | | | (0.01) | (0.1) | <10 V> |
| | | | | <Yellow> | | |
| | 39 | o-Dichlorobenzene | THF(50) | Rubrene | Dibenzo-18-crown-6-ether | 70.1 |
| | | | | (0.01) | (0.05) | <30 V> |
| | | | | <Yellow> | | |
| | 40 | o-Dichlorobenzene | THF(50) | Rubrene | Dibenzofuran (0.1) | 2 |
| | | | | (0.01) | | <30 V> |
| | | | | <Yellow> | | |
| | 40 | o-Dichlorobenzene | THF(50) | Rubrene | Diphenoxyethane (0.1) | 1 |
| | | | | (0.01) | | <30 V> |
| | | | | <Yellow> | | |
| Comp. | 1 | o-Dichlorobenzene | THF(50) | Rubrene | None | 0.6 |
| Ex. | | | | (0.01) | | <8 V> |
| | | | | <Yellow> | | |

As is clear from Table 4, in Examples 32-41 were obtained higher maximum luminances in comparison to Comparative Example 1, in which no luminescence promoting additive was used. Accordingly, an effect of improving luminance was recognized for every luminescence promoting additive used in these Examples.

### EXAMPLES 42-45

The distance of the gap between the electrodes was varied and the influence of the variation was examined. o-Dichlorobenzene was used as solvent 1 and 2-methyltetrahydrofuran was used as solvent 2. Rubrene was used as a luminescent material. 1,2-Diphenoxyethane was used as a luminescence promoting additive.

The gap between the electrodes was varied through changing the size and shape of the spacer interposed between the electrodes. The spacers used were made of resin or silica and were spherical or cylindrical in shape.

The results are shown in Table 5.

TABLE 5

| | | | | Solvent 2 | Luminescent | | |
|---|---|---|---|---|---|---|---|
| | | | | (Vol. | Material | Luminescence | Maximum |
| | | Gap | | Conc. % in | (Conc. mol/l) | Promoting | Luminance |
| | | Between | | Mixed | <Luminescent | Additive | (cd/m²) |
| | | Electrodes | Solvent 1 | Solvent) | Color> | (Conc. mol/l) | <Voltage> |
| Ex. | 42 | 8 μm | o-Dichlorobenzene | 2- | Rubrene | 1,2- | 225 |
| | | | | Methyltetrahydrofuran | (0.01) | Diphenoxyethane | <17 V> |
| | | | | (50) | <Yellow> | (0.1) | |
| | 43 | 3 μm | o-Dichlorobenzene | 2- | Rubrene | 1,2- | 270 |
| | | | | Methyltetrahydrofuran | (0.01) | Diphenoxyethane | <6 V> |
| | | | | (50) | <Yellow> | (0.1) | |
| | 44 | 20 μm | o-Dichlorobenzene | 2- | Rubrene | 1,2- | 166 |
| | | | | Methyltetrahydrofuran | (0.01) | Diphenoxyethane | <25 V> |
| | | | | (50) | <Yellow> | (0.1) | |
| | 45 | 100 μm | o-Dichlorobenzene | 2- | Rubrene | 1,2- | 0.7 |
| | | | | Methyltetrahydrofuran | (0.01) | Diphenoxyethane | <30 V> |
| | | | | (50) | <Yellow> | (0.1) | |

As is clear from Table 5, the maximum luminance decreases as the gap between the electrodes increases as 3 μm, 8 μm, 20 μm and 100 μm. Accordingly, it is revealed that the gap between electrodes is preferably 100 μm or less and more preferably is 10 μm or less.

### EXAMPLES 46-48

The concentration of rubrene, which is a luminescent material, was varied and the influence of the variation was examined. o-Dichlorobenzene was used as solvent 1 and toluene was used as solvent 2. 1,2-Diphenoxyethane was used as a luminescence promoting additive. The results are shown in Table 6.

TABLE 6

| | | | | Luminescent | | |
|---|---|---|---|---|---|---|
| | | | | Material | Luminescence | Maximum |
| | | | Solvent 2 | (Conc. mol/l) | Promoting | Luminance |
| | | | (Vol. Conc. % in | <Luminescent | Additive | (cd/m²) |
| | | Solvent 1 | Mixed Solvent) | Color> | (Conc. mol/l) | <Voltage> |
| Ex. | 46 | o-Dichlorobenzene | Toluene (50) | Rubrene | 1,2-Diphenoxyethane | 3 |
| | | | | (0.0001) | (0.1) | <100 V> |
| | | | | <Yellow> | | |
| | 47 | o-Dichlorobenzene | Toluene (50) | Rubrene | 1,2-Diphenoxyethane | 683 |
| | | | | (0.01) | (0.1) | <100 V> |
| | | | | <Yellow> | | |
| | 48 | o-Dichlorobenzene | Toluene (50) | Rubrene | 1,2-Diphenoxyethane | 750 |
| | | | | (0.01) | (0.1) | <100 V> |
| | | | | <Yellow> | | |

As is clear from Table 6, higher luminances were obtained as the concentration of a luminescent material becomes higher.

### EXAMPLES 49-52

ECL elements were produced using various kinds of luminescent materials. o-Dichlorobenzene was used as solvent 1 and toluene was used as solvent 2. 1,2-Diphenoxyethane was used as a luminescence promoting additive.

The results are shown in Table 7.

TABLE 7

| | | | Solvent 2 | | Luminescence | Maximum |
|---|---|---|---|---|---|---|
| | | | (Vol. Conc. % | Luminescent Material | Promoting | Luminance |
| | | | in Mixed | (Conc. mol/l) | Additive | (cd/m²) |
| | | Solvent 1 | Solvent) | <Luminescent Color> | (Conc. mol/l) | <Voltage> |
| Ex. | 49 | o-Dichlorobenzene | Toluene (50) | 9,10- | 1,2-Diphenoxyethane | 39.5 |
| | | | | Diphenylanthracene | (0.1) | <100 V> |
| | | | | (0.01) <Blue> | | |
| | 50 | o-Dichlorobenzene | Toluene (50) | 5,12- | 1,2-Diphenoxyethane | 86.0 |
| | | | | Diphenylnaphthacene | (0.1) | <100 V> |
| | | | | (0.01) <Green> | | |
| | 51 | o-Dichlorobenzene | Toluene (50) | 6,13- | 1,2-Diphenoxyethane | 1.0 |
| | | | | Diphenylpentacene | (0.1) | <100 V> |
| | | | | (0.01) <Red> | | |
| | 52 | o-Dichlorobenzene | Toluene (50) | Dibenzotetra | 1,2-Diphenoxyethane | 1.5 |
| | | | | (methylphenyl) | (0.1) | <100 V> |
| | | | | perifuranten | | |
| | | | | (0.01) <Red> | | |

As shown in Table 7, a high luminance was obtained for every luminescent material. Blue luminescence was obtained when 9,10-diphenyl anthracene was used as a luminescent material. Green luminescence was obtained when 5,12-diphenylnaphthacene was used as a luminescent material. Red luminescence was obtained when 6,13-diphenylpentacene was used as a luminescent material. Red luminescence was also obtained when dibenzotetra(methylphenyl)perifuranten was used as a luminescent material.

### EXAMPLES 53-55

The sheet resistance of electrodes was varied and the influence of the variation was examined. As shown in Table 8, products with sheet resistances of electrodes of 10 Ω/□, 300 Ω/□ and 1000 Ω/□ were produced. The results are shown in Table 8.

TABLE 8

| | | | | Solvent 2 | Luminescent | | |
|---|---|---|---|---|---|---|---|
| | | | | (Vol. | Material | Luminescene | Maximum |
| | | | | Conc. % in | (Conc. mol/l) | Promoting | Luminance |
| | | Electrode | | Mixed | <Luminescent | Additive | (cd/m²) |
| | | Resistance | Solvent 1 | Solvent) | Color> | (Conc. mol/l) | <Voltage> |
| Ex. | 53 | 10 Ω/□ | o-Dichlorobenzene | Acetonitrile | Rubrene | 1,2- | 183 |
| | | | | (50) | (0.01) | Diphenoxyethane | <8 V> |
| | | | | | <Yellow> | (0.2) | |
| | 54 | 300 Ω/□ | o-Dichlorobenzene | Acetonitrile | Rubrene | 1,2- | 100 |
| | | | | (50) | (0.01) | Diphenoxyethane | <8 V> |
| | | | | | <Yellow> | (0.2) | |
| | 55 | 1000 Ω/□ | o-Dichlorobenzene | Acetonitrile | Rubrene | 1,2- | 1.2 |
| | | | | (50) | (0.01) | Diphenoxyethane | <8 V> |
| | | | | | <Yellow> | (0.2) | |

As is clear from Table 8, the luminance decreases as the sheet resistance of electrodes increases. Accordingly, it is revealed that the sheet resistance of electrodes is preferably 1000 Ω/□ or less.

### EXAMPLE 56

Here, an ECL element was produced using tris(2-phenylpyridine)iridium, which is known as a luminescent material which emits light from a triplet state in an organic EL element. Benzonitrile was as a solvent. No luminescence promoting additive was used. The result is shown in Table 9.

TABLE 9

| | | Solvent 2 | | Luminescence | |
|---|---|---|---|---|---|
| | | (Vol. | | Promoting | Maximum |
| | | Conc. % in | Luminescent Material | Additive | Luminance |
| | | Mixed | (Conc. mol/l) | (Conc. | (cd/m²) |
| | Solvent 1 | Solvent) | <Luminescent Color> | mol/l) | <Voltage> |
| Ex. 56 | Benzonitrile | None | Tris(2- | None | 3 |
| | | | phenylpyridine)iridium | | <16 V> |
| | | | <Green> | | |

As shown in Table 9, it is revealed that a favorable luminance is also obtained when a tris(2-phenylpyridine)iridium is used for an ECL element.

### EXAMPLE 57

The luminescent element the same as Example 2 was AC driven through application of an alternating current voltage with a rectangular wave of a frequency of 30 Hz and a duty ratio of 50%, the voltage changing within the range of +16V to −16V. This element showed a maximum luminance of 180 cd/m². It has been confirmed that this element is able to emit light even after its continuous one-hour emission of light. In contrast to this, when the element of Example 2 was DC driven, almost no light emission was recognized in one hour. From this fact it is revealed that the luminescent element of the present invention can emit light with stability when it is made emit light by AC driving. In DC driving, it is considered that because polarities of the electrodes are fixed, one type of ions derived from the luminescent molecules are distributed unevenly about one electrode of the cathode and the anode through a long emission of light, which makes it hard for recombination to occur. In contrast to this, in AC driving, it is considered that the above-mentioned phenomena are improved because polarities of the electrodes are reversed continuously.

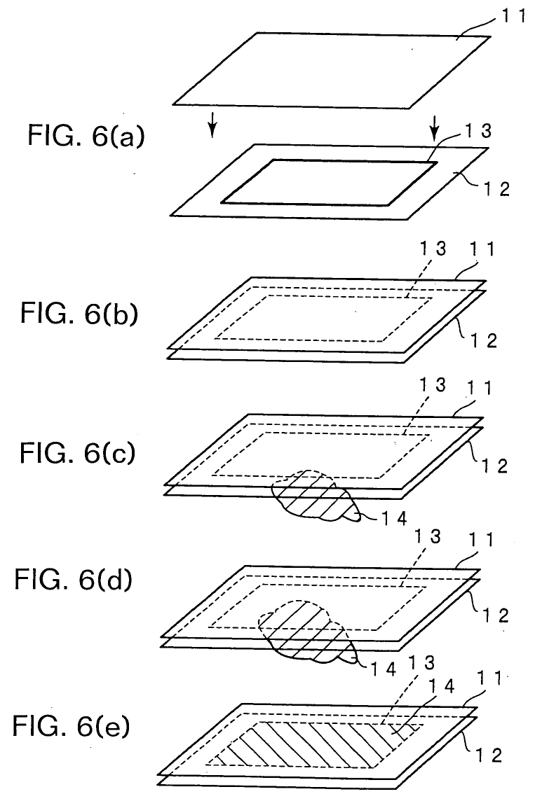

FIG. 6. is a perspective view for illustrating manufacture steps of one embodiment according to the manufacture process of the present invention. As shown in FIG. 6(a), a substrate 11 and a substrate 12 are prepared first. Electrodes made of ITO or the like are formed on the inside faces of substrate 11 and substrate 12. As for the shape of the electrodes, stripe-shaped electrodes perpendicular to each other are formed, for example. A sealing agent 13 is applied to a peripheral portion of at least one of substrate 11 and substrate 12.

Next, substrate 11 and substrate 12 are bonded together, as shown in FIG. 6(b). After exhaustion of the air from the hollow portion inside the sealing agent by vacuum suction, a luminescent solution 14 is injected between substrates 11 and 12, as shown in FIG. 6(c). Because the hollow portion inside the sealing agent 13 is vacuum sucked, it is possible to inject the luminescent solution 14 into the inside of the sealing agent 13 easily and also possible to fill the inside of the sealing agent 13 with the luminescent solution 14.

In the manner mentioned above, the luminescent solution 14 can be held between the paired substrates 11 and 12 as shown in FIG. 6(e).

As mentioned above, by addition of a spacer to the luminescent solution 14, the distance between the electrodes can be held at a gap regulated by the spacer.

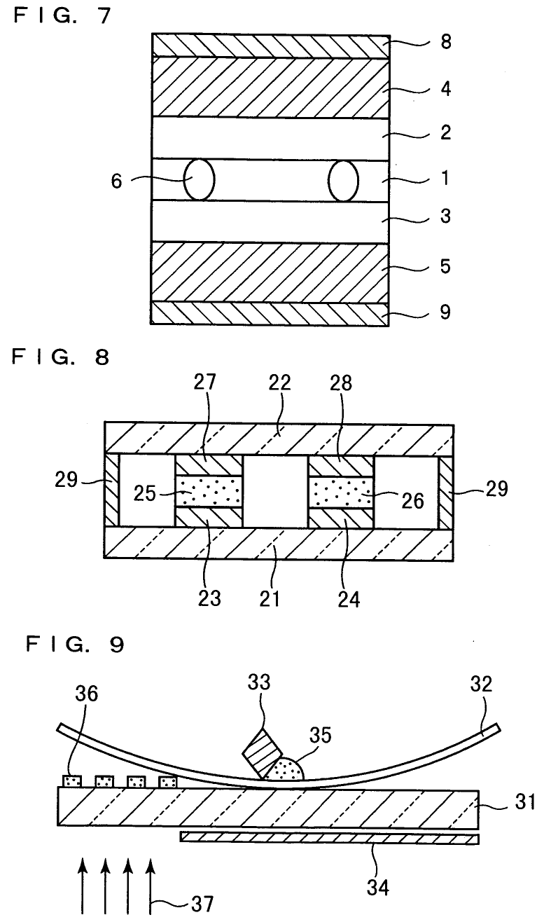

FIG. 7 is a sectional view illustrating the structure of an-ECL element of one embodiment according to the present invention. Here, ultraviolet absorbing films 8 and 9 are attached to the outside of glass substrates 4 and 5, respectively. When such ultraviolet absorbing films 8 and 9 are disposed outside the substrates, ultraviolet rays in the external light can be absorbed. Thus, it is possible to prevent the luminescent material contained in the luminescent solution from being deteriorated by ultraviolet rays.

In the Example shown above an embodiment is presented in which stripe-shaped electrodes are disposed perpendicularly to each other as electrodes for applying voltage to the luminescent solution. However, the ECL element of the present invention is not limited to this and various types of electrodes can be used. For example, ones conventionally employed as electrodes of liquid crystal displays (LCD) are available.

### EXAMPLES 58-62

As shown in Table 10, three or more kinds of solvents were used in combination here. The contents of solvent B-E shown in Table 10 are in volume ratio % relative to 100% of solvent A. Rubrene was used as a luminescent material. 1,2-Diphenoxyethane was used as a luminescence promoting additive. As electrodes, ITO was used for every electrode.

TABLE 10

| | | | | | | | Luminescent | | |
|---|---|---|---|---|---|---|---|---|---|
| | | | | Solvent C | | | Material | Luminescence | Maximum |
| | | | Solvent B | (Vol. Ratio | Solvent D | Solvent E | (Conc. mol/l) | Promoting | Luminance |
| | | | (Vol. Ratio % | % to | (Vol. Ratio % | (Vol. Ratio % | <Luminescent | Additive | (cd/m²) |
| | | Solvent A | to Solvent A) | Solvent A) | to Solvent A) | to Solvent A) | Color> | (Conc. mol/l) | <Voltage> |
| Ex. | 58 | o- | Chloro-enzene | THF(25) | Acetonitrile | None | Rubrene | 1,2-Diphenoxyethane | 105 |
| | | Dichloro- | (30) | | (25) | | (0.01) | (0.1) | <18 V> |
| | | benzene | | | | | <Yellow> | | |
| | 59 | o- | o-Dibromo- | 2-Methyl- | THF(25) | None | Rubrene | 1,2-Diphenoxyethane | 48 |
| | | Dichloro- | benzene (50) | tetrahydro- | | | (0.01) | (0.1) | <16 V> |
| | | benzene | | furan (25) | | | <Yellow> | | |
| | 60 | o- | THF(50) | Acetonitrile | None | None | Rubrene | 1,2-Diphenoxyethane | 205 |
| | | Difluoro- | | (10) | | | (0.01) | (0.1) | <11 V> |
| | | benzene | | | | | <Yellow> | | |
| | 61 | o- | o-Difluoro- | o-Dibromo- | 1-Chloronaphthalene | Acetonitrile | Rubrene | 1,2-Diphenoxyethane | 80 |
| | | Dichloro- | benzene (15) | benzene (10) | (8) | (25) | (0.01) | (0.1) | <15 V> |
| | | benzene | | | | | <Yellow> | | |
| | 62 | o- | THF(25) | Acetonitrile | 2-Methyltetrahydrofuran | None | Rubrene | 1,2-Diphenoxyethane | 201 |
| | | Difluoro- | | (10) | (10) | | (0.01) | (0.1) | <10 V> |
| | | benzene | | | | | <Yellow> | | |

As shown in Table 10, it is revealed that two or more kinds of solvents may be used as the first solvent comprised of a halogen-containing benzene derivative or as the second solvent other than halogen-containing benzene derivatives.

### EXAMPLES 63-65

As shown in Table 11, two or more kinds of luminescent materials were used. The luminescent color of an element can be adjusted by using luminescent materials of different luminescent colors in combination. For example, when luminescent materials which emit light in red (R), green (G) and blue (B), respectively, are combined, it is possible to adjust the luminescent color to white.

ITO was used for every electrode.

TABLE 11

| | | Solvent B | Solvent C | | | | | Luminescence | Maximum |
|---|---|---|---|---|---|---|---|---|---|
| | | (Vol. | (Vol. | Luminescent | Luminescent | Luminescent | | Promoting | Luminance |
| | | Ratio % to | Ratio % to | Material 1 | Material 2 | material 3 | Color of | Additive | (cd/m²) |
| Ex. | Solvent A | Solvent A) | Solvent A) | (Conc. mol/l) | (Conc. mol/l) | (Conc. mol/l) | Element | (Conc. mol/l) | <Voltage> |
| 63 | o- | Chloro- | Toluene | Rubrene | 9,10- | None | Yellowish | 1,2-Dipheno- | 105 |
| | Dichloro- | benzene | (20) | (0.01) | Diphenyl- | | White | xyethane (0.1) | <100 V> |
| | benzene | (30) | | | anthracene | | | | |
| | | | | | (0.01) | | | | |
| 64 | o- | Toluene | None | 9,10- | 5, 12- | Dibenzotetra | White | 1,2-Dipheno- | 25 |
| | Dichloro- | (50) | | Diphenyl- | Diphenyl- | (methylphenyl) | | xyethane | <100 V> |
| | benzene | | | anthracene | naphthacene | perifuracene | | (0.1) | |
| | | | | (0.01) | (0.01) | | | | |
| 65 | o- | THF(50) | Acetonirile | Rubrene | 5, 12- | None | Yellowish | 1,2-Dipheno- | 150 |
| | Dichloro- | | (10) | (0.01) | Diphenyl- | | Green | xyethane | <11 V> |
| | benzene | | | | naphthacene | | | (0.1) | |
| | | | | | (0.01) | | | | |

As is clear from Table 11, it is possible to adjust the luminescent color by combining two or more kinds of luminescent materials.

### EXAMPLES 66-67

As shown in Table 12, two or more kinds of luminescence promoting additives were used. o-Dichlorobenzene and acetonitrile were used as solvents and rubrene was used as a luminescent material. ITO was used for every electrode.

TABLE 12

| | | | Luminescent | | | | |
|---|---|---|---|---|---|---|---|
| | | Solvent B | Material | Luminescence | Luminescence | Luminescence | Maximum |
| | | (Vol. | (Conc. mol/l) | Promoting | Promoting | Promoting | Luminance |
| | | Ratio % to | <Luminescent | Additive 1 | Additive 2 | Additive 3 | (cd/m²) |
| Ex. | Solvent A | Solvent A) | Color> | (Conc. mol/l) | (Conc. mol/l) | (Conc. mol/l) | <Voltage> |
| 66 | o- | Acetonitrile | Rubrene | 1,2-Dipheno- | Dibenzo-18- | None | 150 |
| | Dichloro- | (50) | (0.01) | xyethane | crown-6-ether | | <18 V> |
| | benzene | | <Yellow> | (0.1) | (0.05) | | |
| 67 | o- | Acetonitrile | Rubrene | 1,2-Dipheno- | Dibenzo-18- | 1,2-Dimetho- | 160 |
| | Dichloro- | (50) | (0.01) | xyethane | crown-6-ether | xyethane | <19 V> |
| | benzene | | <Yellow> | (0.1) | (0.05) | (0.1) | |

As shown in Table 12, in the present invention, two or more kinds of luminescence promoting additives may be used in combination.

### EXAMPLES 68-72

As shown in Table 13, electrodes made of different materials were employed as electrodes. In such cases, an electrode of a larger work function was used for an anode and an electrode of a smaller work function was used as a cathode. In the case of using an electrode to be laminated to ITO, the electrode was laminated on ITO.

In Example 69, an ITO electrode on which a Pt metal electrode had been formed was used for an anode and an ITO electrode on which a Cs metal electrode had been formed was used for a cathode. The thickness of the Pt metal electrode of the anode is 10 nm and the thickness of the Cs metal electrode of the cathode is 30 nm.

In Example 70, an ITO electrode on which an Mg metal electrode had been formed was used for a cathode. The thickness of the Mg metal electrode is 100 nm.

In Example 71, an ITO electrode on which an Au metal electrode had been formed was used for an anode. The thickness of the Au metal electrode is 10 nm. Moreover, an ITO electrode on which an AILi alloy electrode had been formed was used for a cathode. The thickness of the AILi alloy is 100 nm and the ratio of Al/Li is 99/1.

In Example 72, an ITO electrode on which an LaB₆ electrode had been formed was used for a cathode. The thickness of the LaB₆ electrode is 10 nm.

| | | | Difference | | | | | |
|---|---|---|---|---|---|---|---|---|
| | | | in Work | | | | | |
| | | | Function | | | Luminescent | | |
| | Electrode 1 | Electrode 2 | between | | | Material | Luminescence | |
| | (Work function eV) | (Work Function eV) | Electrode 1 | | Solvent B | (Conc. | Promoting | Maximum |
| | Connected to Plus | Connected to Minus | and | | (Vol. | mol/l) | Additive | Luminance |
| | Terminal of DC | Terminal of DC | Electrode 2 | | ratio % to | <Luminescent | (Conc. | (cd/m²) |
| Ex. | Source | Source | (eV) | Solvent A | Solvent A) | Color> | mol/l) | <Voltage> |
| 68 | In₂O₃ with ZnO Added | ITO (4.7) | 0.3 eV | o-Dichloro- | Acetoni- | Rubrene | 1,2-Dipheno- | 200 |
| | (5.0) | | | benzene | trile (50) | (0.01) | xyethane | <10 V> |
| | | | | | | <Yellow> | (0.1) | |
| 69 | Pt/ITO (Pt was on | Cs/ITO (Cs was on | 3.55 eV | o-Dichloro- | Acetoni- | Rubrene | 1,2-Dipheno- | 20 |
| | the liquid side; | the liquid side; | | benzene | trile (50) | (0.01) | xyethane | <9 V> |
| | Work Function of Pt = | Work Function of Cs = | | | | <Yellow> | (0.1) | |
| | 5.35 eV; | 1.8 eV; Thickness | | | | | | |
| | Thickness of Pt = | of Cs = 30 nm) | | | | | | |
| | 10 nm) | | | | | | | |
| 70 | ITO (4.7) | Mg/ITO (Mg was on | 1.05 eV | o-Dichloro- | Acetoni- | Rubrene | 1,2-Dipheno- | 30 |
| | | the liquid side; | | benzene | trile (50) | (0.01) | xyethane | <9 V> |
| | | Work Function of Mg = | | | | <Yellow> | (0.1) | |
| | | 3.65 eV; | | | | | | |
| | | Thickness of Mg = | | | | | | |
| | | 100 nm) | | | | | | |
| 71 | AU/ITO (Au was on | AlLi alloy/ITO | 1.6 eV | o-Dichloro- | Acetoni- | Rubrene | 1,2-Dipheno- | 80 |
| | the liquid side; | (AlLi alloy was on | | benzene | trile (50) | (0.01) | xyethane | <14 V> |
| | Work Function of Au = | the liquid side; | | | | <Yellow> | (0.1) | |
| | 4.8 eV; Thickness | Work Function of | | | | | | |
| | of Au = 10 nm) | AlLi alloy = 3.2 | | | | | | |
| | | eV; Thickness of | | | | | | |
| | | AlLi alloy = 100 | | | | | | |
| | | nm; Al/Li = 99/1) | | | | | | |
| 72 | ITO (4.7) | LaB₆/ITO (LaB₆ was | 2.0 eV | o-Dichloro- | Acetoni- | Rubrene | 1,2-Dipheno- | 75 |
| | | on the liquid side; | | benzene | trile (50) | (0.01) | xyethane | <13 V> |
| | | Work Function of | | | | <Yellow> | (0.1) | |
| | | LaB₆ = 2.7 eV; | | | | | | |
| | | Thickness of LaB₆ = | | | | | | |
| | | 10 nm) | | | | | | |

In comparison to Example 27 shown in Table 3, in which ITO was used for both electrodes, Examples 68-72 shown in Table 13 provide better luminescent efficiencies. Therefore, it is revealed that the luminescent efficiency can be enhanced by making the difference in work function be 0.1-3.55 eV through use of electrodes of different materials as electrodes.

### EXAMPLES 73-78

As shown in Table 14, various kinds of iridium-containing organic compounds were used as a luminescent material. In Example 74, an iridium-containing compound having the structure shown in (Chem. 33) was used. In Example 75, the iridium-containing compound having the structure shown in (Chem. 34) was used as a luminescent material. In Example 76, the iridium-containing compound having the structure shown in (Chem. 35) was used as a luminescent material. In Example 77, the iridium-containing compound having the structure shown in (Chem. 36) was used as a luminescent material. In Example 78, the iridium-containing compound having the structure shown in (Chem. 37) was used as a luminescent material.

TABLE 14

| | | | Luminescent | | Maximum |
|---|---|---|---|---|---|
| | | | Material | Luminescence | Lum- |
| | | Solvent 2 | (Conc. mol/l) | Promoting | inance |
| | | (Vol. Conc. % in | <Luminescent | Additive | (cd/m²) |
| | Solvent 1 | Mixed Solvent) | Color> | (Conc. mol/l) | <Voltage> |
| Ex. 73 | Benzonitrile | None | Tris(2- | None | 3 |
| | | | phenylpyridine) | | <16 V> |
| | | | iridium | | |
| | | | (0.01) <Green> | | |
| Ex. 74 | Benzonitrile | None | ppy2 Ir(acac) | None | 5 |
| | | | (0.01) <Green> | | <15 V> |
| Ex. 75 | Benzonitrile | None | pq2 Ir(acac) | None | 5 |
| | | | (0.01) <Orange> | | <16 V> |
| Ex. 76 | Benzonitrile | None | pq2 Ir(acac) | 1,2-Dipheno- | 7 |
| | | | (0.01) <Orange> | xyethane (0.2) | <16 V> |
| Ex. 77 | o-Dichloro- | THF (50) | btp2 Ir(acac) | None | 10 |
| | benzene | | (0.01) <Red> | | |
| Ex. 78 | o-Dichloro- | Toluene (50) | Firpic (0.01) | None | 10 |
| | benzene | | <Blue> | | <100 V> |

[Chem. 33]

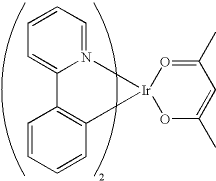

ppy2 Ir(acac)
bis(2-phenylpyridinato-M,C2)iridium(acetylacetonate)
[Chem. 34]

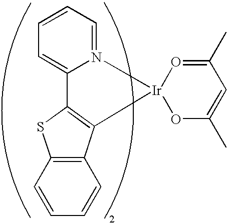

btp2 Ir(acac)
bis(2-(2′-benzothienyl)pyridinato-N,C3′)iridium
(acetylacetonate)
[Chem. 35]

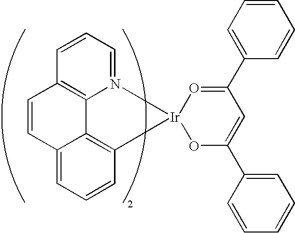

bzq2 Ir(dbm)
bis(benzoquinolinato)iridium(dibenzoylmethanate)
[Chem. 36]

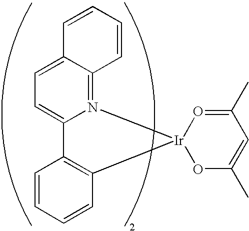

pq2 Ir(acac)
bis(2-phenylquinolinato-N,C2)iridium
(acetylacetonate)
[Chem. 37]

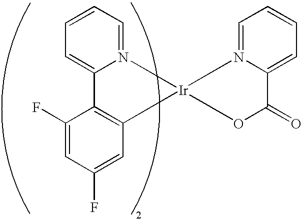

Firpic
bis(4,6-di-fluorophenyl)-pyridinato-N,C2′)
iridium(picolinate)

As shown in Table 14, it is revealed that iridium-containing compounds show a good luminance when they are used as a luminescent material of an ECL element.

FIG. 8 is a schematic sectional view showing a luminescent element of one embodiment according to the fourth aspect of the present invention. A glass substrate 22 is disposed above a glass substrate 21 so that they face each other. On glass substrate 21, transparent electrodes 23 and 24 made of ITO are formed so as to correspond to pixel regions. Also on glass substrate 22, transparent electrodes 27 and 28 made of ITO are formed so as to correspond to pixel regions. A luminescent section 25 is formed between opposed transparent electrodes 23 and 27. Similarly, a luminescent section 26 is formed between opposed transparent electrodes 24 and 28. In each of luminescent sections 25 and 26, a luminescent solution containing a luminescent material and a solvent is gelled by macromolecules contained in a luminescent region and is held in a gel state. Because luminescent sections 25 and 26 do not have flowability, they are held between transparent electrodes 23 and 27 and between transparent electrodes 24 and 28, respectively.

A sealing agent 29 is put in peripheral portions of glass substrates 21 and 22. The inside of the luminescent element sandwiched between glass substrates 21 and 22 is sealed with the sealing agent 29.

According to the present invention, a luminescent solution containing a luminescent material and a solvent is held in luminescent sections 25 and 26 while being divided into pixel to pixel. Therefore, it is possible to provide a different luminescent color to each pixel, thereby achieving multicoloration and full coloration.

Furthermore, because no partitions or the like are required for holding a luminescent solution in a pixel region, pixels can be formed easily.

FIG. 9 is a schematic sectional view for illustrating a manufacture step in one embodiment of the manufacture process according to the fifth aspect of the present invention. In the process shown in FIG. 9, a luminescent section 36 is formed on a glass substrate 31 by screen printing. On glass substrate 31 is disposed a screen 32 patterned so that a luminescent section could be formed in a predetermined pattern. On screen 32, a squeegee 33 is arranged. Squeegee 33 is moved on screen 32 in the direction of arrow A. A luminescent solution 35 is placed on the side toward which squeegee 33 moves. Luminescent solution 35 is applied to a predetermined part on glass substrate 31 through screen 32 while squeegee 33 is move in the direction of A.

Although not shown, a transparent electrode is formed in a predetermined site on glass substrate 31. Onto a pixel region in a predetermined site on the transparent electrode, a luminescent solution 35 is applied. Under glass substrate 31 is disposed an ultraviolet light shielding board 34, which covers a portion, forward which squeegee 33 is moved, ahead of the portion where squeegee 33 is located. The luminescent solution which has been applied through screen 32 by passing of squeegee 33 forms a region out of ultraviolet light shielding board 34. Therefore, it is exposed to ultraviolet irradiation 37 and a polymerizable material in a luminescence region is caused to polymerize. Thereby, a luminescent solution gels to form a luminescent section 36.

In the manner described above, it is possible to form a luminescent section 36 by applying a luminescent solution 35 onto glass substrate 31 while patterning so as to divide into each pixel by use of screen 32 and causing the luminescent solution to gel through irradiation of the luminescent solution applied with ultraviolet rays 37.

Hereinafter, specific embodiments according to the fourth aspect of the present invention are illustrated.

### EXAMPLE 79

A luminescent element was prepared by screen printing shown in FIG. 9 using the following luminescent solutions A and B as a luminescent solution.

The contents in % by weight of the monomers and oligomers shown below indicate the contents relative to the solvent.

<Luminescent Solution A>

Monomer: 30% by weigh of ethylene glycol ethyl carbonate methacrylate.

Luminescent material: 1% by weight of rubrene.

Solvent: Mixed solvent of o-dichlorobenzene and acetonitrile in a volume ratio 2:1.

Luminescence promoting additive: 4% by weight of diphenoxyethane.

<Luminescent Solution B>

Monomer: 30% by weigh of ethylene glycol ethyl carbonate methacrylate.

Luminescent material: 1% by weight of diphenylnaphthacene.

Solvent: Mixed solvent of o-dichlorobenzene and acetonitrile in a volume ratio 2:1.

Luminescence promoting additive: 4% by weight of diphenoxyethane.

First, the above luminescent solution A was used, which was applied to a predetermined site of a transparent electrode formed on a glass substrate 31 by the screen printing shown in FIG. 9. After the application, ultraviolet rays with a wavelength of 350-365 nm were irradiated to polymerize the monomers in the luminescent solution, thereby forming a luminescent section.

Next, luminescent solution B was used. This was applied similarly onto a transparent electrode of a glass substrate and was applied with ultraviolet rays to gel, thereby forming a luminescent section.

After forming the luminescent sections as described above, the glass substrate having thereon a transparent electrode was put on the luminescent section to form an element structure of glass substrate/transparent electrode/luminescent section/transparent electrode/glass substrate.

A voltage shown in Table 15 was applied to the electrodes of the luminescent elements obtained. From the luminescent section prepared from luminescent solution A, a yellow luminescence was observed. From the luminescent section prepared from luminescent solution B, a green luminescence was observed. Luminances and luminescent peaks are shown in Table 15.

TABLE 15

| Luminescent | | | Luminescent | Luminescent |
|---|---|---|---|---|
| Solution | Voltage | Luminance | Color | Peak |
| A | 8 V | 150 cd/m² | Yellow | 560 nm |
| B | 8 V | 130 cd/m² | Green | 520 nm |

### EXAMPLE 80

A luminescent element was prepared in the same manner as Example 79 above except applying luminescent solutions A and B by the inkjet technique in place of the screen printing. From the luminescent element, luminescence characteristics the same as those of Example 79 were obtained.

### EXAMPLE 81

A luminescent element was produced in the same manner as Example 79 except using luminescent solution C shown below as a luminescent solution. The luminescent element obtained was evaluated for its luminescence characteristics by applying thereto a voltage shown in Table 16. The evaluation results are shown in Table 16.

<Luminescent Solution C>

Monomer: 25% by weight of methyl methacrylate Luminescent material: 2% by weight of rubrene.

Solvent: Mixed solvent of o-dichlorobenzene and tetrahydrofuran in a volume ratio of 2:1

Luminescence promoting additive: 4% by weight of diphenoxyethane.

TABLE 16

| Luminescent | | | Luminescent | Luminescent |
|---|---|---|---|---|
| Solution | Voltage | Luminance | Color | Peak |
| C | 10 V | 130 cd/m² | Yellow | 560 nm |

### EXAMPLE 82

A luminescent element was produced in the same manner as Example 79 except using luminescent solution D shown below as a luminescent solution. The luminescent element obtained was evaluated for its luminescence characteristics by applying thereto a voltage shown in Table 17. The evaluation results are shown in Table 17.

<Luminescent Solution D>

Oligomer: 20% by weight of bisphenol type epoxyacrylates.

Luminescent material: 1% by weight of rubrene

Solvent: Mixed solvent of o-dichlorobenzene and tetrahydrofuran in a volume ratio of 2:1.

Luminescence promoting additive: 4% by weight of diphenoxyethane.

TABLE 17

| Luminescent | | | Luminescent | Luminescent |
|---|---|---|---|---|
| Solution | Voltage | Luminance | Color | Peak |
| D | 9 V | 140 cd/m² | Yellow | 560 nm |

### EXAMPLE 83

A luminescent element was produced in the same manner as Example 79 except using luminescent solution E shown below as a luminescent solution. The luminescent element obtained was evaluated for its luminescence characteristics by applying thereto a voltage shown in Table 18. The evaluation results are shown in Table 18.

<Luminescent Solution E>

Oligomer: 20% by weight of urethane acrylate.

Luminescent material: 1% by weight of rubrene.

Solvent: Mixed solvent of o-dichlorobenzene and tetrahydrofuran in a volume ratio of 2:1.

Luminescence promoting additive: 4% by weight of diphenoxyethane.

TABLE 18

| Luminescent | | | Luminescent | Luminescent |
|---|---|---|---|---|
| Solution | Voltage | Luminance | Color | Peak |
| E | 10 V | 150 cd/m² | Yellow | 560 nm |

### EXAMPLE 84

A luminescent element was prepared in the same manner as Example 79 except using luminescent solution F shown below as a luminescent solution and, after its application, carrying out polymerization not under ultraviolet irradiation but under heating. The luminescent element obtained was evaluated for its luminescence characteristics by applying thereto a voltage shown in Table 19. The evaluation results are shown in Table 19.

<Luminescent Solution F>

Oligomer: 20% by weight of polyester acrylates.

Luminescent material: 1% by weight of rubrene.

Solvent: Mixed solvent of o-dichlorobenzene and tetrahydrofuran in a volume ratio of 2:1.

Luminescence promoting additive: 4% by weight of diphenoxyethane.

TABLE 19

| Luminescent | | | Luminescent | Luminescent |
|---|---|---|---|---|
| Solution | Voltage | Luminance | Color | Peak |
| F | 10 V | 140 cd/m² | Yellow | 560 nm |

### EXAMPLE 85

A luminescent element was produced in the same manner as Example 79 except using luminescent solution G shown below as a luminescent solution. The luminescent element obtained was evaluated for its luminescence characteristics by applying thereto a voltage shown in Table 20. The evaluation results are shown in Table 20.

<Luminescent Solution G>

Oligomer: 20% by weight of polybutadiene acrylate.

Luminescent material: 1% by weight of rubrene

Solvent: Mixed solvent of o-dichlorobenzene and tetrahydrofuran in a volume ratio of 2:1.

Luminescence promoting additive: 4% by weight of diphenoxyethane.

TABLE 20

| Luminescent | | | Luminescent | Luminescent |
|---|---|---|---|---|
| Solution | Voltage | Luminance | Color | Peak |
| G | 9 V | 130 cd/m² | Yellow | 560 nm |

According to the fourth aspect of the present invention, because a luminescent section where a luminescent solution is held is formed while being divided for every pixel, a pixel region can be formed easily. Moreover, because a luminescent section is formed while being divided for every pixel, different luminescent colors can be allocated to pixel to pixel and it can support multicoloration and full coloration easily.

Field of Industrial Application

According to the present invention, light emission can be achieved with stability and an ECL element with a high luminance can be afforded.

Moreover, according to the manufacture process of the present invention, an ECL element can be manufactured efficiently.

1. A luminescent element having an element structure in which a luminescent solution containing a luminescent material and a solvent is held between a pair of electrodes, wherein a luminescence promoting additive comprising a nonionic compound which stabilizes the luminescent material is contained in the luminescent solution.

2. The luminescent element according to claim 1, wherein the luminescence promoting additive has a diether structure, a crown ether structure or a polyethylene glycol structure.

3. The luminescent element according to claim 1 or 2, wherein the luminescence promoting additive is at least one selected from 1,2-dimethoxyethane, 1,2-diethoxyethane, bis(2-ethoxyethyl) ether, 1,2-diphenoxyethane, 1,2-dibenzyloxyethane, 1,2-bis(tosyloxy)ethane, ethylene glycol bis[4-(ethoxycarbonyl)phenyl] ether, 1,3-diphenoxybenzene, ethylene glycol dibenzoate, diphenoxy methane, 1,4-diphenoxybenzene, 3,3′-ethylene dioxydiphenol, polyethylene glycol and dibenzo-18-crown-6-ether.

4. The luminescent element according to any one of claims 1 to 3, wherein at least a halogen-containing benzene derivative is contained as the solvent.

5. The luminescent element according to any one of claims 1 to 4, wherein the solvent is a mixed solvent containing a first solvent comprising a halogen-containing benzene derivative and a second solvent other than the halogen-containing benzene derivative.

6. The luminescent element according to claim 4 or 5, wherein the halogen-containing benzene derivative is at least one selected from chlorobenzene, dichlorobenzene, trichlorobenzene, fluorobenzene, difluorobenzene, trifluorobenzene, bromobenzene, dibromobenzene, and chloronaphthalene.

7. The luminescent element according to claim 5 or 6, wherein the second solvent has a specific inductive capacity of 1.9 to 90 at room temperature.

8. The luminescent element according to any one of claims 5 to 7, wherein the second solvent is at least one selected from acetonitrile, 2-methyltetrahydrofuran, toluene, propylene carbonate, ethylene carbonate, tetrahydrofuran, benzonitrile, cyclohexane, normal hexane, acetone, N,N-dimethylformamide, nitrobenzene, 1,3-dioxolane, furan and benzotrifluoride.

9. The luminescent element according to any one of claims 5 to 8, wherein the mixing volume ratio of the first solvent to the second solvent (the first solvent/the second solvent) is 99/1 to 10/90.

10. The luminescent element according to any one of claims 1 to 9, wherein the luminescent material is a condensed multicyclic aromatic compound or an organometallic compound having fluorescence or phosphorescence in the visible region.

11. The luminescent element according to any one of claims 1 to 10, wherein the luminescent material is at least one selected from naphthacene derivatives, anthracene derivatives, pentacene derivatives, perifuranten derivatives and iridium-containing organometallic compounds.

12. The luminescent element according to any one of claims 1 to 11, wherein the concentration of the luminescent material in the luminescent solution is 0.0001 to 0.5 mol/l.

13. The luminescent element according to any one of claims 1 to 12, wherein the molar ratio of the luminescence promoting additive to the luminescent material (molar concentration of the luminescence promoting additive/molar concentration of luminescent material) is 0.1 to 1000.

14. The luminescent element according to any one of claims 1 to 12, wherein the molar ratio of the luminescence promoting additive to the luminescent material (molar concentration of the luminescence promoting additive/molar concentration of luminescent material) is 10 to 500.

15. The luminescent element according to any one of claims 1 to 14, wherein at least one of the pair of electrodes has a visible light transmittance of 30% or higher.

16. The luminescent element according to any one of claims 1 to 15, wherein at least one of the pair of electrodes is formed of indium tin oxide.

17. The luminescent element according to any one of claims 1 to 15, wherein at least one of the pair of electrodes is formed of at least one metal oxide selected from SnO₂ with Sb added; In₂O₃ with ZnO added; In₂O₃ with SnO₂ added; In₂O₃, SnO₂, ZnO and Cd₂SnO₄, each doped with fluorine; elemental metal or alloy metal selected from Li, Na, Cs, Sr, Ba, Ca, Eu, Mg, In, Mn, Ti, Ta, V, Al, Zn, MO, Ag, Fe, Cu, Sn, Bi, Ni, Pd, Au, Ir and Pt; or lanthanide hexaboride selected from LaB₆, CeB₆, PrB₆, NdB₆, SmB₆, EuB₆ and GdB₆.

18. The luminescent element according to any one of claims 1 to 17, wherein the pair of electrodes are those made of different materials.

19. The luminescent element according to claims 18, wherein the difference in work function between the different materials is 0.1 to 3.55 eV.

20. The luminescent element according to any one of claims 1 to 19, wherein the pair of electrodes have a sheet resistance of 1000 Ω/□ or less.

21. The luminescent element according to any one of claims 1 to 20, wherein at least one of the pair of electrodes is formed on a glass substrate or a plastic substrate.

22. The luminescent element according to claim 21, wherein an ultraviolet absorbing film is disposed outside the substrate.

23. The luminescent element according to any one of claims 1 to 22, wherein the pair of electrodes have therebetween a gap of 100 μm or less.

24. The luminescent element according to claim 23, wherein the gap is maintained by interposing a spacer between the pair of electrodes.

25. A luminescent element having an element structure in which a luminescent solution containing a luminescent material and a solvent is held between a pair of electrodes, wherein a material which emits light from its triplet state is used as the luminescent material.

26. The luminescent element according to claim 25, wherein the luminescent material is an iridium-containing organic compound.

27. The luminescent element according to claim 26, wherein the luminescent material is tris(2-phenylpyridine)iridium.

28. The luminescent element according to any one of claims 1 to 27, wherein the luminescent solution is caused to emit light through application of a direct current voltage to the pair of electrodes.

29. The luminescent element according to any one of claims 1 to 27, wherein the luminescent solution is caused to emit light through application of an alternating current voltage to the pair of electrodes.

30. The luminescent element according to any one of claims 1 to 29, wherein the solvent or a compound constituting the solvent has a coefficient of viscosity ranging 0.2 to 20 mPa.S.

31. A luminescent solution which emits light through application of a voltage while being held between a pair of electrodes, wherein the luminescent solution contains a luminescent material, a solvent and a luminescence promoting additive comprising a nonionic compound which stabilizes the luminescent material.

32. The luminescent solution according to claim 31 which is the luminescent solution recited in any one of claims 2 to 30.

33. The luminescent element according to any one of claims 1 to 30, which element comprises a luminescent section in which the luminescent solution is held while being divided into every pixel, and a pair of electrodes disposed so as to hold the luminescent section therebetween.

34. The luminescent element according to claim 33, wherein the luminescent solution is held in a gel state in the luminescent section.

35. The luminescent element according to claim 34, wherein the luminescent solution is held in a gel state by a macromolecule contained in the luminescent solution.

36. A process for manufacturing a luminescent element, which process comprises a step of applying a luminescent solution containing a luminescent material, a solvent and a polymerizable substance to a substrate while patterning the solution so that the solution may be divided into every pixel, and a step of polymerizing the polymerizable substance in the luminescent solution applied to allow the luminescent solution to gelate, thereby forming a luminescent section.

37. The process for manufacturing a luminescent element according to claim 36, wherein the polymerizable substance is polymerized by ultraviolet irradiation or heating.

38. A process for manufacturing a luminescent element having an element structure in which a luminescent solution containing a luminescent material and a solvent is held between a pair of electrodes, which process comprises forming each of the pair of electrodes on a substrate, applying a sealing agent to a peripheral portion of each of the substrates, bonding the substrates so that the electrode surfaces are opposed to each other, exhausting air from a hollow portion between the substrates, and injecting the luminescent solution between the substrate.
